(19) United States
(12) Patent Application Publication
(10) Pub. No.: US 2009/0067737 A1
(43) Pub. Date: Mar. 12, 2009

(54) CODING APPARATUS, CODING METHOD, DECODING APPARATUS, DECODING METHOD, AND PROGRAM

(75) Inventors: Noriaki TAKAHASHI, Tokyo (JP); Tetsujiro Kondo, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/186,849

(22) Filed: Aug. 6, 2008

(30) Foreign Application Priority Data
Sep. 6, 2007 (JP) 2007-231128

(51) Int. Cl. G06K 9/36

(52) U.S. Cl. 382/251

(57) ABSTRACT

A coding apparatus includes a blocking unit configured to divide an image into blocks, a reference value acquiring unit configured to acquire two reference values not smaller and not greater than a pixel value of a focused pixel, a reference value difference calculation unit configured to calculate a reference value difference, a pixel value difference calculation unit configured to calculate a pixel value difference between the value of the focused pixel and the reference value, a quantization unit configured to quantize the pixel value difference based on the reference value difference, an operation parameter calculation unit configured to determine an operation parameter that is used in a predetermined operation and minimizes a difference between the pixel value of the focused pixel and the reference value, and an output unit configured to output a quantization result and the operation parameter as a coded result of an image.

### CROSS REFERENCES TO RELATED APPLICATIONS

The present invention contains subject matter related to Japanese Patent Application JP 2007-231128 filed in the Japanese Patent Office on Sep. 6, 2007, the entire contents of which are incorporated herein by reference.

### BACKGROUND OF THE INVENTION

1. Field of the Invention

The present invention relates to coding apparatuses, coding methods, decoding apparatuses, decoding methods, and programs. More particularly, the present invention relates to a coding apparatus and a decoding apparatus that provide a decoded result having a quality preferable to humans, for example, by reducing a quantization error, to a coding method, a decoding method, and a program.

2. Description of the Related Art

Various image compression methods have been suggested. For example, adaptive dynamic range coding (ADRC) is available as one of those methods (see, for example, Japanese Patent Application Publication No. 61-144989).

The ADRC according to the related art will be described with reference to FIG. 1.

FIG. 1 shows pixels constituting a given block using the horizontal axis representing a location (x, y) and the vertical axis representing a pixel value.

In the ADRC according to the related art, an image is divided into a plurality of blocks. A maximum value MAX and a minimum value MIN of pixels included in a block are detected. A difference DR=MAX−MIN between the maximum value MAX and the minimum value MIN is set as a local dynamic range of the block. A pixel value of a pixel included in the block is re-quantized into an n-bit value on the basis of this dynamic range DR (here, the value n is smaller than the number of bits of the original pixel value).

More specifically, in the ADRC, the minimum value MIN is subtracted from each pixel value p_{x,y} of the block and the subtracted value (p_{x,y}−MIN) is divided by a quantization step (a step between a given quantized value and the next quantized value) Δ=DR/2ⁿ based on the dynamic range DR. The divided value (p_{x,y}−MIN)/Δ (here, all numbers after the decimal point are discarded) resulting from the division is treated as an ADRC coded value (ADRC code) of the pixel value p_{x,y}.

### SUMMARY OF THE INVENTION

In ADRC according the related art, since pixel values of all pixels included in a block are quantized on the basis of a common dynamic range DR as shown in FIG. 1, that is, since the pixel values are quantized on the basis of an identical quantization step Δ=DR/2ⁿ, an ADRC quantization error increases in a block having a greater difference between the maximum value MAX and the minimum value MIN.

In view of such a circumstance, an embodiment of the present invention provides a decoded result having a quality preferable to humans by reducing a quantization error.

A coding apparatus or a program according to an embodiment of the present invention is a coding apparatus that encodes an image or a program allowing a computer to function as a coding apparatus that encodes an image. The coding apparatus includes or the program allows the computer to function as blocking means for dividing the image into a plurality of blocks, reference value acquiring means for acquiring two reference values that are a value not smaller than a pixel value of a focused pixel and a value not greater than the pixel value of the focused pixel when each pixel included in the block is set as the focused pixel, reference value difference calculation means for calculating a reference value difference that is a difference between the two reference values, pixel value difference calculation means for calculating a pixel value difference that is a difference between the pixel value of the focused pixel and the reference value, quantization means for quantizing the pixel value difference on the basis of the reference value difference, operation parameter calculation means for determining an operation parameter that is used in a predetermined operation for determining the reference values and that minimizes a difference between the pixel value of the focused pixel and the reference value determined in the predetermined operation using the operation parameter, and output means for outputting a result of quantization performed by the quantization means and the operation parameter as a coded result of the image.

When the predetermined operation is a linear operation that uses a fixed coefficient and a representative value representing the block, the operation parameter calculation means may determine the representative value as the operation parameter.

When the reference value not greater than the pixel value of the focused pixel, among the two reference values, is referred to as a first reference value and the reference value not smaller than the pixel value of the focused pixel is referred to as a second reference value, the operation parameter calculation means may determine, for each block, a first representative value used in determining the first reference value and a second representative value used in determining the second reference value, and the reference value acquiring means may determine the first reference value using the fixed coefficient and the first representative value and the second reference value using the fixed coefficient and the second representative value to acquire the first and second reference values.

When the predetermined operation is a linear operation that uses a predetermined coefficient and a maximum pixel value or a minimum pixel value of the block serving as a representative value representing the block, the operation parameter calculation means may determine the predetermined coefficient as the operation parameter.

When the reference value not greater than the pixel value of the focused pixel, among the two reference values, is referred to as a first reference value and the reference value not smaller than the pixel value of the focused pixel is referred to as a second reference value and the minimum pixel value of the block is set as a first representative value and the maximum pixel value of the block is set as a second representative value, the operation parameter calculation means may determine a first coefficient used in determining the first reference value along with the first representative value and a second coefficient used in determining the second reference value along with the second representative value, and the reference value acquiring means may determine the first reference value using the first coefficient and the first representative value and the second reference value using the second coefficient and the second representative value to acquire the first and second reference values.

A coding method according to an embodiment of the present invention is a coding method for a coding apparatus that encodes an image. The coding method includes the steps of dividing the image into a plurality of blocks, acquiring two reference values that are a value not smaller than a pixel value of a focused pixel and a value not greater than the pixel value of the focused pixel when each pixel included in the block is set as the focused pixel, calculating a reference value difference that is a difference between the two reference values, calculating a pixel value difference that is a difference between the pixel value of the focused pixel and the reference value, quantizing the pixel value difference on the basis of the reference value difference, determining an operation parameter that is used in a predetermined operation for determining the reference values and that minimizes a difference between the pixel value of the focused pixel and the reference value determined in the predetermined operation using the operation parameter, and outputting a result of quantization of the pixel value difference and the operation parameter as a coded result of the image.

In the embodiment of the present invention, the image is divided into a plurality of blocks. Two reference values that are not smaller than the pixel value of the focused pixel and not greater than the pixel value of the focused pixel are acquired while setting each pixel included in the block as the focused pixel. The reference value difference between the two reference values is calculated and the pixel value difference between the pixel value of the focused pixel and the reference value is calculated. The pixel value difference is quantized on the basis of the reference value difference. The operation parameter that is used in the predetermined operation for determining the reference values and that minimizes the difference between the pixel value of the focused pixel and the reference value determined in the predetermined operation using the operation parameter is determined. The quantized result of the pixel value difference and the operation parameter are output as the coded result of the image.

A decoding apparatus or a program according to another embodiment of the present invention is a decoding apparatus that decodes coded data of an image or a program allowing a computer to function as a decoding apparatus that decodes coded data of an image. The coded data includes a quantized result of a pixel value difference and an operation parameter obtained by calculating a reference value difference between two reference values that are a value not smaller than a pixel value of a focused pixel and a value not greater than the pixel value of the focused pixel when each pixel of a block resulting from division of an image into blocks is set as the focused pixel, by calculating the pixel value difference between the pixel value of the focused pixel and the reference value, by quantizing the pixel value difference on the basis of the reference value difference, and by determining the operation parameter that is used in a predetermined operation for determining the reference values and that minimizes a difference between the pixel value of the focused pixel and the reference value determined in the predetermined operation using the operation parameter. The decoding apparatus includes or the program allows the computer to function as reference value acquiring means for performing the predetermined operation using the operation parameter to acquire the two reference values, reference value difference acquiring means for acquiring the reference value difference that is a difference between the two reference values, dequantization means for dequantizing the quantized result on the basis of the reference value difference to determine the pixel value difference, and addition means for adding the pixel value difference and the reference value.

When the operation parameter is a representative value representing the block, the reference value acquiring means may perform a linear operation that uses a fixed coefficient and the representative value as the predetermined operation to acquire the reference values.

When the reference value not greater than the pixel value of the focused pixel, among the two reference values, is referred to as a first reference value and the reference value not smaller than the pixel value of the focused pixel is referred to as a second reference value, the operation parameters are a first representative value used in determining the first reference value and a second representative value used in determining the second reference value that are determined for each block, and the reference value acquiring means may determine the first reference value using the fixed coefficient and the first representative value and the second reference value using the fixed coefficient and the second representative value to acquire the first and second reference values.

When the operation parameter is a predetermined coefficient, the reference value acquiring means may perform a linear operation, as the predetermined operation, using the predetermined coefficient and a minimum pixel value or a maximum pixel value of the block serving as the representative value representing the block to acquire the reference values.

When the reference value not greater than the pixel value of the focused pixel, among the two reference values, is referred to as a first reference value and the reference value not smaller than the pixel value of the focused pixel is referred to as a second reference value and the minimum pixel value of the block is set as a first representative value and the maximum pixel value of the block is set as a second representative value, the operation parameters are a first coefficient used in determining the first reference value along with the first representative value and a second coefficient used in determining the second reference value along with the second representative value, and the reference value acquiring means may determine the first reference value using the first coefficient and the first representative value and the second reference value using the second coefficient and the second representative value to acquire the first and second reference values.

A decoding method according to another embodiment of the present invention is a decoding method for a decoding apparatus that decodes coded data of an image. The coded data includes a quantized result of a pixel value difference and an operation parameter obtained by calculating a reference value difference between two reference values that are a value not smaller than a pixel value of a focused pixel and a value not greater than the pixel value of the focused pixel when each pixel of a block resulting from division of an image into blocks is set as the focused pixel, by calculating the pixel value difference between the pixel value of the focused pixel and the reference value, by quantizing the pixel value difference on the basis of the reference value difference, and by determining the operation parameter that is used in a predetermined operation for determining the reference values and that minimizes a difference between the pixel value of the focused pixel and the reference value determined in the predetermined operation using the operation parameter. The method includes steps of performing the predetermined operation using the operation parameter to acquire the reference values, acquiring the reference value difference that is a difference between the two reference values, dequantizing the quantized result on the basis of the reference value difference to determine the pixel value difference, and adding the pixel value difference and the reference value.

In the embodiment of the present invention, the predetermined operation is performed using the operation parameter to acquire the reference values. The reference value difference between the two reference values is acquired. The quantized result is dequantized on the basis of the reference value difference, whereby the pixel value difference is determined. The pixel value difference and the reference value are added.

According to embodiments of the present invention, a decoded result having a quality preferable to humans can be obtained by reducing a quantization error.

### BRIEF DESCRIPTION OF THE DRAWINGS

FIG. 1 is a diagram illustrating ADRC according to the related art;

FIG. 2 is a block diagram showing a configuration example of an image transmission system according to an embodiment of the present invention;

FIG. 3 is a block diagram showing a first configuration example of a coding apparatus 31 shown in FIG. 2;

FIG. 4 is a diagram illustrating a method for determining a first reference value b_{x,y};

FIG. 5 is a diagram showing a first reference value b_{x,y} and a second reference value t_{x,y} that are optimized so that a sum of reference value differences D_{x,y} is minimized;

FIG. 6 is a flowchart illustrating a coding process performed by a coding apparatus 31 shown in FIG. 3;

FIG. 7 is a block diagram showing a first configuration example of a decoding apparatus 32 shown in FIG. 2;

FIG. 8 is a flowchart illustrating a decoding process performed by a decoding apparatus 32 shown in FIG. 7;

FIG. 9 is a diagram showing an S/N ratio of decoded image data;

FIG. 10 is a block diagram showing a second configuration example of a coding apparatus 31 shown in FIG. 2;

FIG. 11 is a diagram illustrating a coding process performed by a coding apparatus 31 shown in FIG. 10;

FIG. 12 is a block diagram showing a second configuration example of a decoding apparatus 32 shown in FIG. 2;

FIG. 13 is a flowchart illustrating a decoding process performed by a decoding apparatus 32 shown in FIG. 12;

FIG. 14 is a diagram showing four methods for calculating a first reference value b_{x,y} and a second reference value t_{x,y};

FIG. 15 is a diagram showing a fixed second reference value t_{x,y} and an optimized first reference value b_{x,y};

FIG. 16 is a diagram showing a fixed first reference value b_{x,y} and an optimized second reference value t_{x,y}; and

FIG. 17 is a block diagram showing a configuration example of a computer.

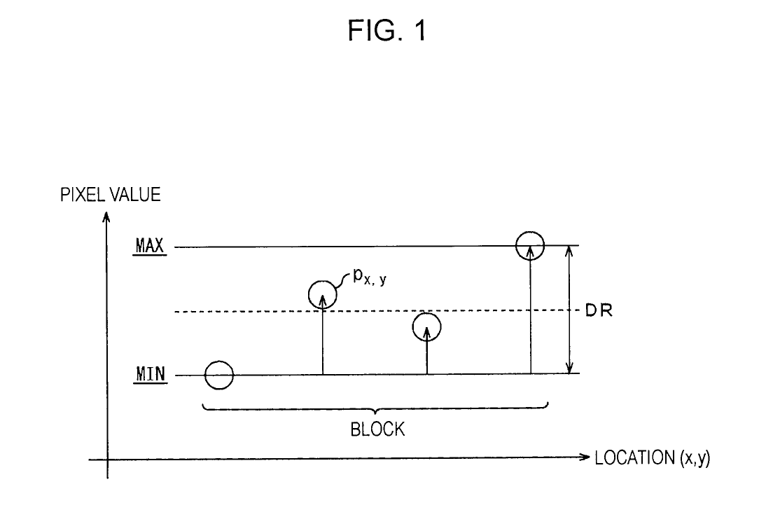

### DESCRIPTION OF THE PREFERRED EMBODIMENTS

Before describing embodiments of the present invention, the correspondence between the features of the present invention and the specific elements disclosed in this specification and the attached drawings is discussed below. This description is intended to assure that embodiments supporting the claimed invention are described in this specification and the attached drawings. Thus, even if an element in the following embodiments is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

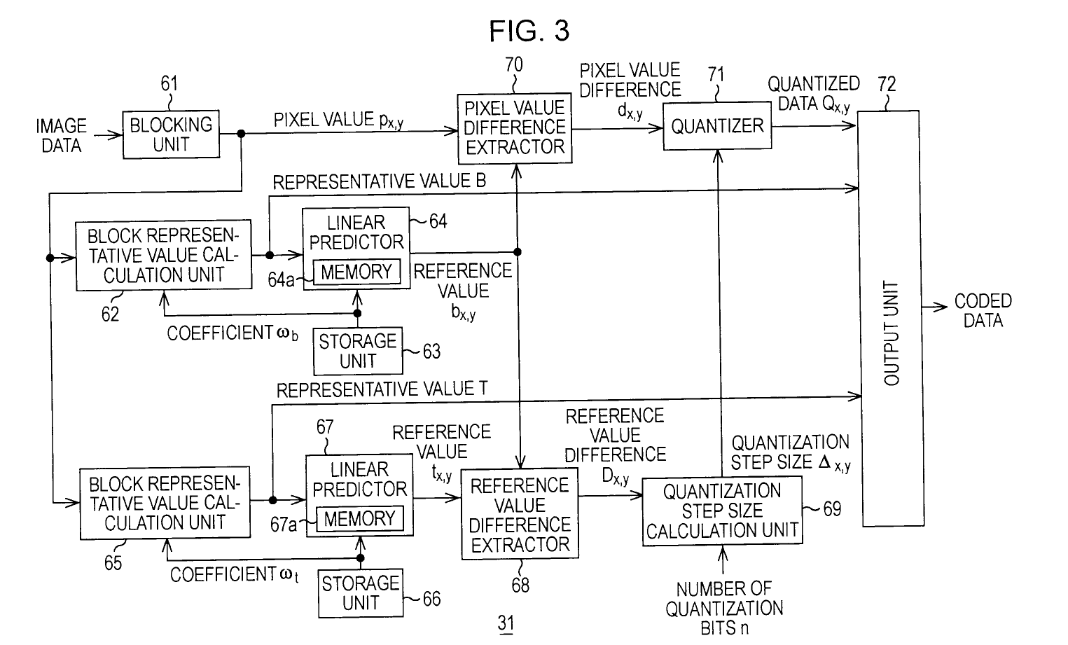

A coding apparatus or a program according to an embodiment of the present invention is a coding apparatus (e.g., a coding apparatus 31 shown in FIG. 3) that encodes an image or a program allowing a computer to function as a coding apparatus that encodes an image. The coding apparatus includes or the program allows the computer to function as blocking means (e.g., a blocking unit 61 shown in FIG. 3) for dividing the image into a plurality of blocks, reference value acquiring means (e.g., linear predictors 64 and 67 shown in FIG. 3) for acquiring two reference values that are a value not smaller than a pixel value of a focused pixel and a value not greater than the pixel value of the focused pixel when each pixel included in the block is set as the focused pixel, reference value difference calculation means (e.g., a reference value difference extractor 68 shown in FIG. 3) for calculating a reference value difference that is a difference between the two reference values, pixel value difference calculation means (e.g., a pixel value difference extractor 70 shown in FIG. 3) for calculating a pixel value difference that is a difference between the pixel value of the focused pixel and the reference value, quantization means (e.g., a quantizer 71 shown in FIG. 3) for quantizing the pixel value difference on the basis of the reference value difference, operation parameter calculation means (e.g., block representative value calculation units 62 and 65 shown in FIG. 3) for determining an operation parameter that is used in a predetermined operation for determining the reference values and that minimizes a difference between the pixel value of the focused pixel and the reference value determined in the predetermined operation using the operation parameter, and output means (e.g., an output unit 72 shown in FIG. 3) for outputting a result of quantization performed by the quantization means and the operation parameter as a coded result of the image.

When the reference value not greater than the pixel value of the focused pixel, among the two reference values, is referred to as a first reference value (e.g., a reference value b_{x,y} shown in FIG. 3) and the reference value not smaller than the pixel value of the focused pixel is referred to as a second reference value (e.g., a reference value t_{x,y} shown in FIG. 3), the operation parameter calculation means (e.g., block representative value calculation units 62 and 65 shown in FIG. 3) may determine, for each block, a first representative value (e.g., a representative value B shown in FIG. 3) used in determining the first reference value and a second representative value (e.g., a representative value T shown in FIG. 3) used in determining the second reference value, and the reference value acquiring means (e.g., linear predictors 64 and 67 shown in FIG. 3) may determine the first reference value using the fixed coefficient (e.g., a coefficient ω_{b} shown in FIG. 3) and the first representative value and the second reference value using the fixed coefficient (e.g., a coefficient ωₜ shown in FIG. 3) and the second representative value to acquire the first and second reference values.

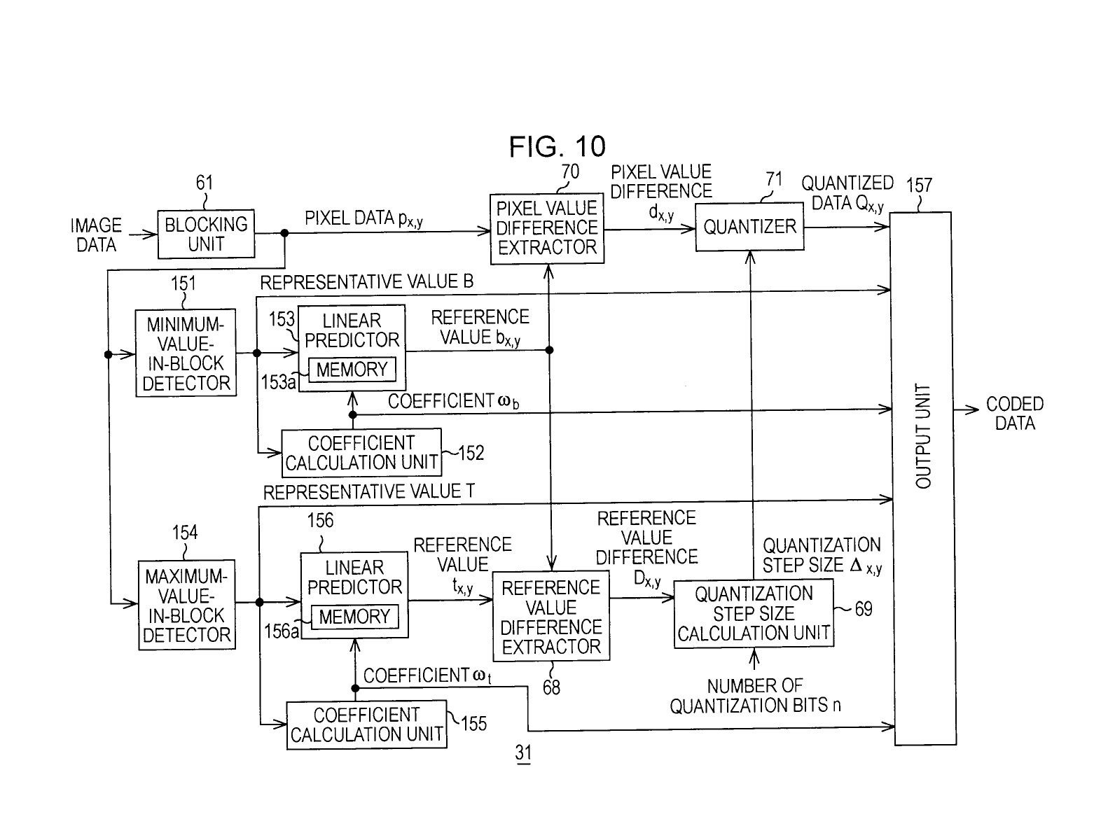

When the reference value not greater than the pixel value of the focused pixel, among the two reference values, is referred to as a first reference value (e.g., a reference value b_{x,y} shown in FIG. 10) and the reference value not smaller than the pixel value of the focused pixel is referred to as a second reference value (e.g., a reference value t_{x,y} shown in FIG. 10) and the minimum pixel value of the block is set as a first representative value (e.g., a representative value B shown in FIG. 10) and the maximum pixel value of the block is set as a second representative value (e.g., a representative value T shown in FIG. 10), the operation parameter calculation means (e.g., coefficient calculation units 152 and 155 shown in FIG. 10) may determine a first coefficient (e.g., a coefficient ω_{b} shown in FIG. 10) used in determining the first reference value along with the first representative value and a second coefficient (e.g., a coefficient ωₜ shown in FIG. 10) used in determining the second reference value along with the second representative value, and the reference value acquiring means (e.g., linear predictors 153 and 156 shown in FIG. 10) may determine the first reference value using the first coefficient and the first representative value and the second reference value using the second coefficient and the second representative value to acquire the first and second reference values.

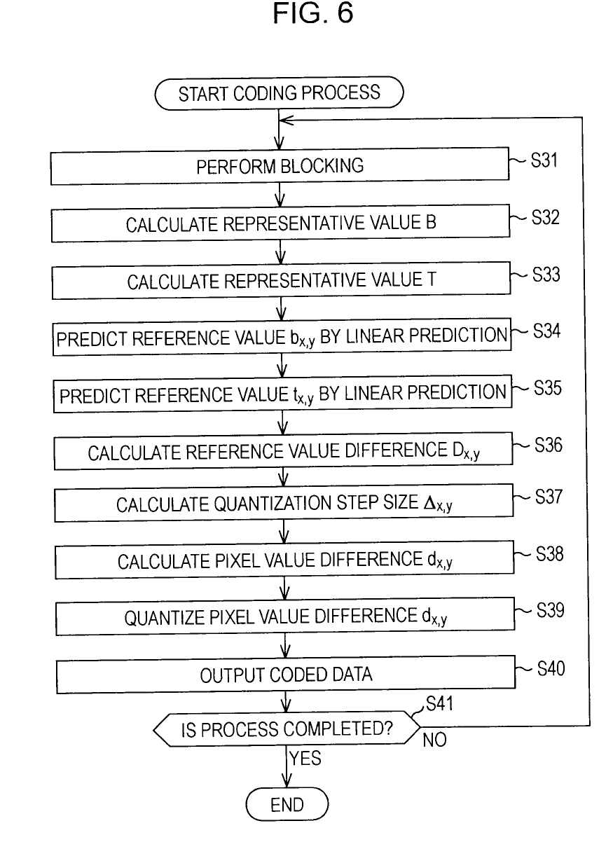

A coding method according to an embodiment of the present invention is a coding method for a coding apparatus (e.g., a coding apparatus 31 shown in FIG. 3) that encodes an image. The coding method includes the steps of dividing the image into a plurality of blocks (e.g., STEP S31 shown in FIG. 6), acquiring two reference values that are a value not smaller than a pixel value of a focused pixel and a value not greater than the pixel value of the focused pixel when each pixel included in the block is set as the focused pixel (e.g., STEPs S34 and S35 shown in FIG. 6), calculating a reference value difference that is a difference between the two reference values (e.g., STEP S36 shown in FIG. 6), calculating a pixel value difference that is a difference between the pixel value of the focused pixel and the reference value (e.g., STEP S38 shown in FIG. 6), quantizing the pixel value difference on the basis of the reference value difference (e.g., STEP S39 shown in FIG. 6), determining an operation parameter that is used in a predetermined operation for determining the reference values and that minimizes a difference between the pixel value of the focused pixel and the reference value determined in the predetermined operation using the operation parameter (e.g., STEPs S32 and S33 shown in FIG. 6), and outputting a result of quantization of the pixel value difference and the operation parameter as a coded result of the image (e.g., STEP S40 shown in FIG. 6).

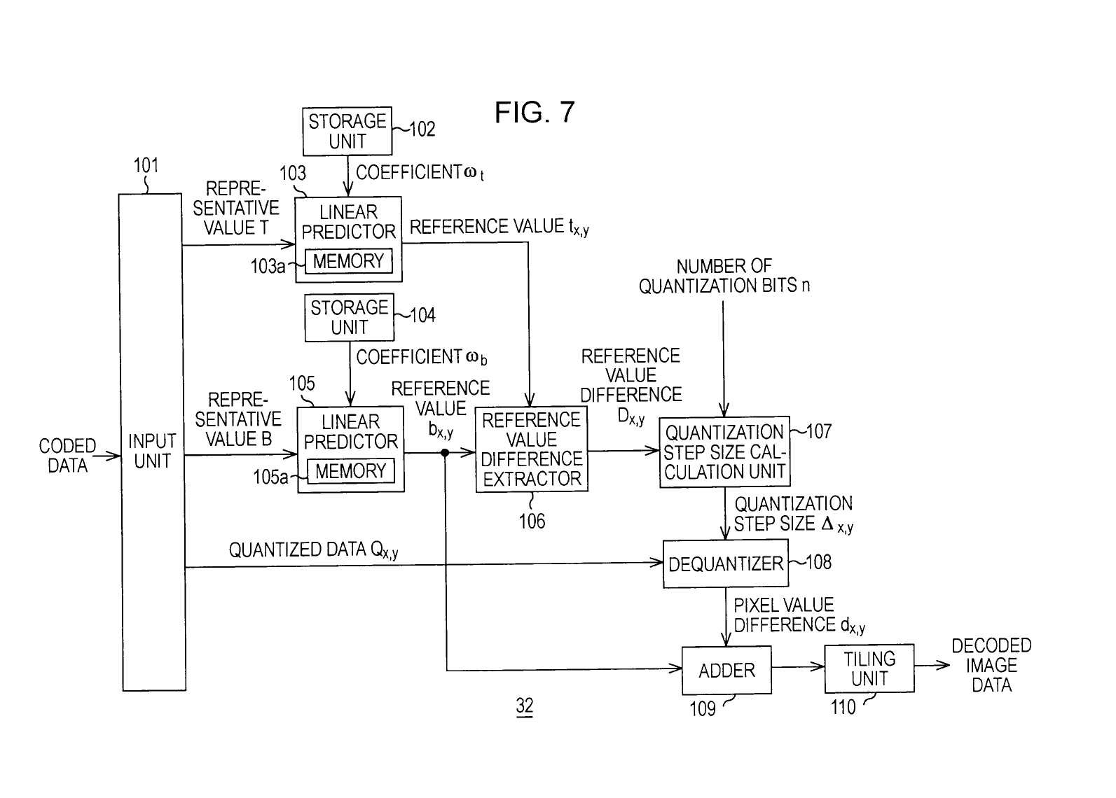

A decoding apparatus or a program according to another embodiment of the present invention is a decoding apparatus (e.g., a decoding apparatus 32 shown in FIG. 7) that decodes coded data of an image or a program allowing a computer to function as a decoding apparatus that decodes coded data of an image. The coded data includes a quantized result of a pixel value difference and an operation parameter obtained by calculating a reference value difference between two reference values that are a value not smaller than a pixel value of a focused pixel and a value not greater than the pixel value of the focused pixel when each pixel of a block resulting from division of an image into blocks is set as the focused pixel, by calculating the pixel value difference between the pixel value of the focused pixel and the reference value, by quantizing the pixel value difference on the basis of the reference value difference, and by determining the operation parameter that is used in a predetermined operation for determining the reference values and that minimizes a difference between the pixel value of the focused pixel and the reference value determined in the predetermined operation using the operation parameter. The decoding apparatus includes or the program allows the computer to function as reference value acquiring means (e.g., linear predictors 103 and 105 shown in FIG. 7) for performing the predetermined operation using the operation parameter to acquire the two reference values, reference value difference acquiring means (e.g., a reference value difference extractor 106 shown in FIG. 7) for acquiring the reference value difference that is a difference between the two reference values, dequantization means (e.g., a dequantizer 108 shown in FIG. 7) for dequantizing the quantized result on the basis of the reference value difference to determine the pixel value difference, and addition means (e.g., an adder 109 shown in FIG. 7) for adding the pixel value difference and the reference value.

When the reference value not greater than the pixel value of the focused pixel, among the two reference values, is referred to as a first reference value (e.g., a reference value b_{x,y} shown in FIG. 7) and the reference value not smaller than the pixel value of the focused pixel is referred to as a second reference value (e.g., a reference value t_{x,y} shown in FIG. 7), the operation parameters are a first representative value (e.g., a representative value B shown in FIG. 7) used in determining the first reference value and a second representative value (e.g., a representative value T shown in FIG. 7) used in determining the second reference value that are determined for each block, and the reference value acquiring means (e.g., linear predictors 103 and 105 shown in FIG. 7) may determine the first reference value using the fixed coefficient (e.g., a coefficient ω_{b} shown in FIG. 7) and the first representative value and the second reference value using the fixed coefficient (e.g., a coefficient ωₜ shown in FIG. 7) and the second representative value to acquire the first and second reference values.

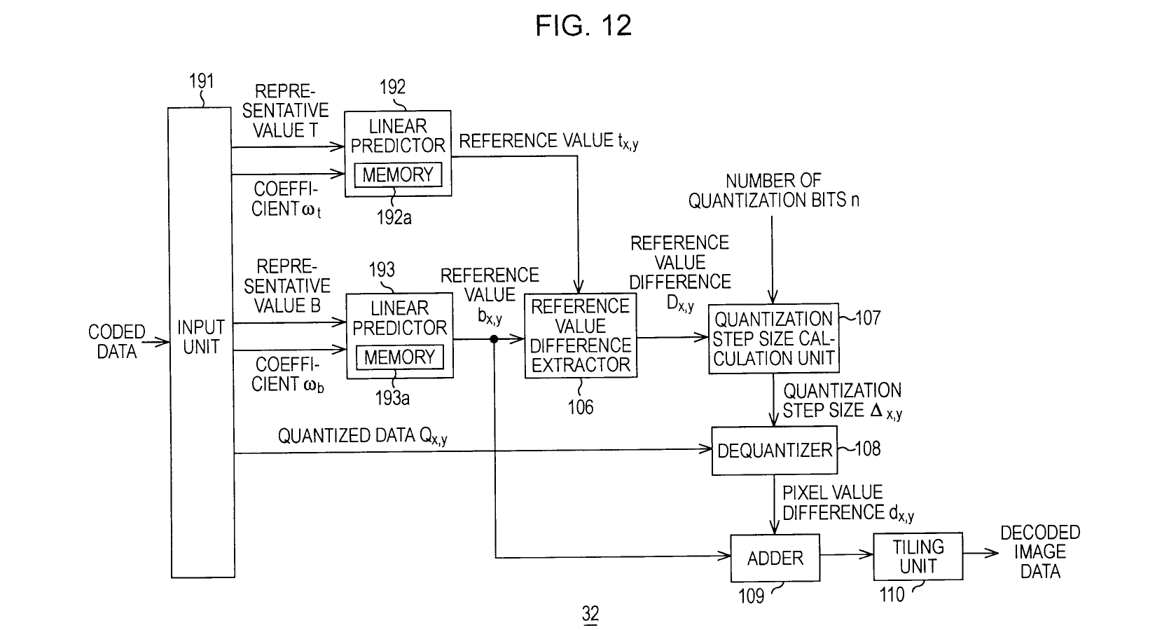

When the reference value not greater than the pixel value of the focused pixel, among the two reference values, is referred to as a first reference value (e.g., a reference value b_{x,y} shown in FIG. 12) and the reference value not smaller than the pixel value of the focused pixel is referred to as a second reference value (e.g., a reference value t_{x,y} shown in FIG. 12) and the minimum pixel value of the block is set as a first representative value (e.g., a representative value B shown in FIG. 12) and the maximum pixel value of the block is set as a second representative value (e.g., a representative value T shown in FIG. 12), the operation parameters are a first coefficient (e.g., a coefficient ω_{b} shown in FIG. 12) used in determining the first reference value along with the first representative value and a second coefficient (e.g., a coefficient ωₜ shown in FIG. 12) used in determining the second reference value along with the second representative value, and the reference value acquiring means (e.g., linear predictors 192 and 193 shown in FIG. 12) may determine the first reference value using the first coefficient and the first representative value and the second reference value using the second coefficient and the second representative value to acquire the first and second reference values.

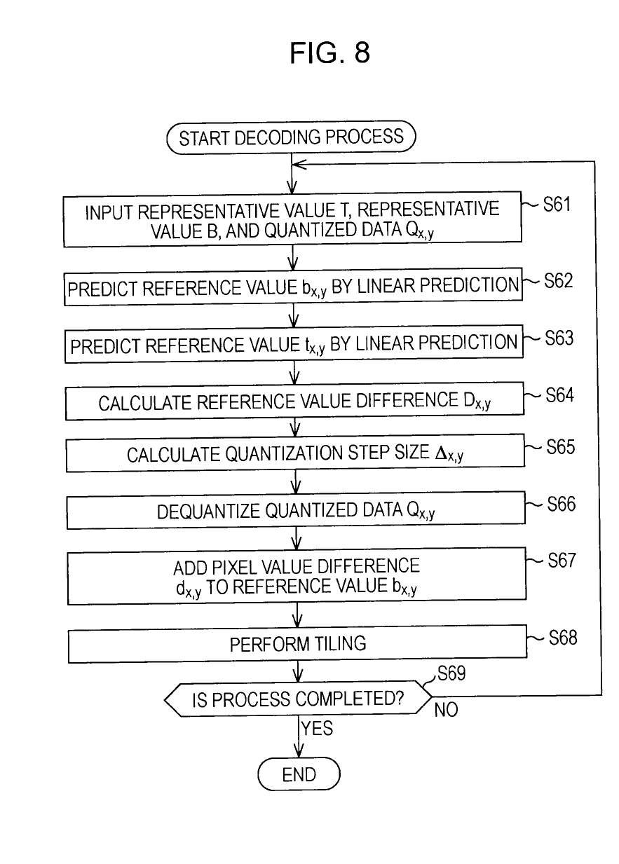

A decoding method according to another embodiment of the present invention is a decoding method for a decoding apparatus (e.g., a decoding apparatus 32 shown in FIG. 7) that decodes coded data of an image. The coded data includes a quantized result of a pixel value difference and an operation parameter obtained by calculating a reference value difference between two reference values that are a value not smaller than a pixel value of a focused pixel and a value not greater than the pixel value of the focused pixel when each pixel of a block resulting from division of an image into blocks is set as the focused pixel, by calculating the pixel value difference between the pixel value of the focused pixel and the reference value, by quantizing the pixel value difference on the basis of the reference value difference, and by determining the operation parameter that is used in a predetermined operation for determining the reference values and that minimizes a difference between the pixel value of the focused pixel and the reference value determined in the predetermined operation using the operation parameter. The method includes steps of performing the predetermined operation using the operation parameter to acquire the reference values (e.g., STEPs S62 and S63 shown in FIG. 8), acquiring the reference value difference that is a difference between the two reference values (e.g., STEP S64 shown in FIG. 8), dequantizing the quantized result on the basis of the reference value difference to determine the pixel value difference (e.g., STEP S66 shown in FIG. 8), and adding the pixel value difference and the reference value (e.g., STEP S67 shown in FIG. 8).

Embodiments of the present invention will now be described with reference to the attached drawings.

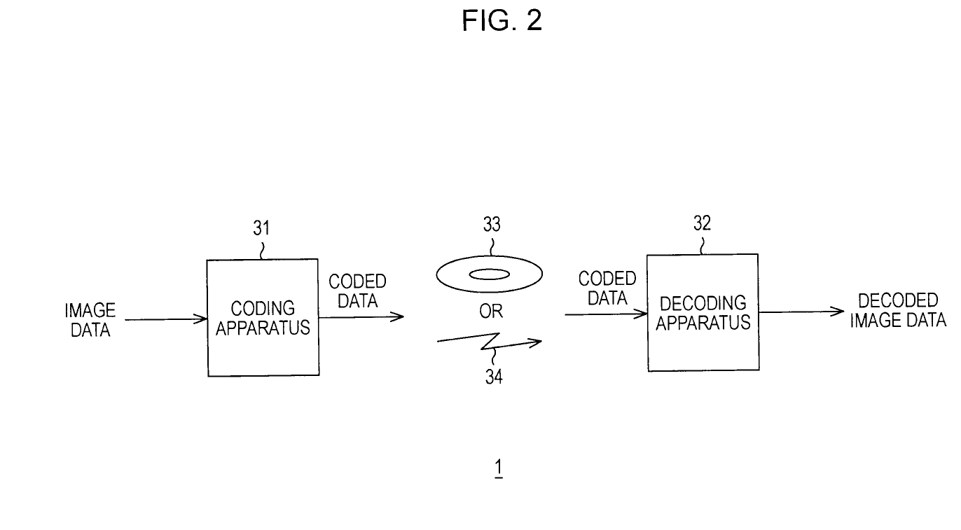

FIG. 2 shows a configuration example of an image transmission system according to an embodiment of the present invention.

An image transmission system 1 shown in FIG. 2 includes a coding apparatus 31 and a decoding apparatus 32.

Image data to be transmitted is supplied to the coding apparatus 31. The coding apparatus 31 (re-)quantizes the supplied image data to encode the data.

Coded data resulting from coding of the image data performed by the coding apparatus 31 is recorded on a recording medium 33, such as, for example, a semiconductor memory, a magneto-optical disk, a magnetic disk, an optical disk, a magnetic tape, and a phase change disk. Alternatively, the coded data is transmitted via a transmission medium 34, such as, for example, a ground wave, a satellite network, a cable television network, the Internet, and a public line.

The decoding apparatus 32 receives the coded data through the recording medium 33 or the transmission medium 34. The decoding apparatus 32 decodes the coded data by dequantizing the data. Decoded image data resulting from this decoding is supplied to a display (not shown) and an image corresponding to the decoded data is displayed on the display, for example.

FIG. 3 is a block diagram showing a first configuration example of the coding apparatus 31 shown in FIG. 2.

The coding apparatus 31 shown in FIG. 3 includes a blocking unit 61, a block representative value calculation unit 62, a storage unit 63, a linear predictor 64 including a memory 64a, a block representative value calculation unit 65, a storage unit 66, a linear predictor 67 including a memory 67a, a reference value difference extractor 68, a quantization step size calculation unit 69, a pixel value difference extractor 70, a quantizer 71, and an output unit 72.

The blocking unit 61 is supplied with coding-target image data of, for example, one frame (or one field). The blocking unit 61 treats the supplied (image data of) one frame as a focused frame. The blocking unit 61 performs blocking to divide the focused frame into a plurality of blocks including a predetermined number of pixels. The blocking unit 61 then supplies the blocks to the block representative value calculation units 62 and 65 and the pixel value difference extractor 70.

The block representative value calculation unit 62 calculates, for each block, a first representative value B representing the respective block of the focused frame on the basis of the blocks supplied from the blocking unit 61 and a first coefficient ω_{b} stored in the storage unit 63. The block representative value calculation unit 62 supplies the first representative value B to the linear predictor 64 and the output unit 72.

The storage unit 63 stores a fixed coefficient ω_{b} as the first coefficient ω_{b}, which is used in determining a first reference value b_{x,y} not greater than a pixel value p_{x,y} of a focused pixel along with the first representative value B while setting each pixel of the respective block as the focused pixel.

Here, the pixel value p_{x,y} represents a pixel value of a pixel located on the x-th column from the left and the y-th row from the top of the focused frame.

For example, a coefficient used in linear interpolation of pixels (pixel values) to enlarge an image or the like can be employed as the fixed coefficient ω_{b}.

The linear predictor 64 stores the first representative value B of each block supplied from the block representative value calculation unit 62 in the memory 64a included therein.

The linear predictor 64 performs a linear operation using the first representative value B stored in the memory 64a and the first coefficient ω_{b} stored in the storage unit 63 to determine the first reference value b_{x,y} not greater than the pixel value p_{x,y} of the focused pixel. The linear predictor 64 supplies the determined first reference value b_{x,y} to the reference value difference extractor 68 and the pixel value difference extractor 70.

The block representative value calculation unit 65 calculates, for each block, a second representative value T representing the respective block of the focused frame on the basis of the blocks supplied from the blocking unit 61 and a second coefficient ωₜ stored in the storage unit 66. The block representative value calculation unit 65 supplies the second representative value T to the linear predictor 67 and the output unit 72.

The storage unit 66 stores a fixed coefficient ωₜ as the second coefficient ωₜ, which is used in determining a second reference value t_{x,y} not smaller than the pixel value p_{x,y} of the focused pixel along with the second representative value T.

For example, a coefficient used in linear interpolation of pixels to enlarge an image or the like can be employed as the fixed coefficient ωₜ.

The linear predictor 67 stores the second representative value T of each block supplied from the block representative value calculation unit 65 in the memory 67a included therein.

The linear predictor 67 performs a linear operation using the second representative value T stored in the memory 67a and the second coefficient ωₜ stored in the storage unit 66 to determine the second reference value t_{x,y} not smaller than the pixel value p_{x,y} of the focused pixel. The linear predictor 67 supplies the second reference value t_{x,y} to the reference value difference extractor 68.

The reference value difference extractor 68 calculates a reference value difference D_{x,y}(=t_{x,y}−b_{x,y}), which is a difference between the second reference value t_{x,y} supplied from the linear predictor 67 and the first reference value b_{x,y} supplied from the linear predictor 64. The reference value difference extractor 68 supplies the reference value difference D_{x,y} to the quantization step size calculation unit 69.

The quantization step size calculation unit 69 calculates, on the basis of the reference value difference D_{x,y} supplied from the reference value difference extractor 68, a quantization step Δ_{x,y} for use in quantization of the pixel value p_{x,y} of the focused pixel. The quantization step size calculation unit 69 then supplies the determined quantization step Δ_{x,y} to the quantizer 71. The quantization step size calculation unit 69 is supplied with the number of quantization bits (the number of bits used for representing one pixel) n to be assigned to quantized image data by a circuit (not shown), for example, according to a user operation or an image quality (signal-to-noise (S/N) ratio) of decoded image data. The quantization step Δ_{x,y} is calculated according to an equation Δ_{x,y}=D_{x,y}/2ⁿ.

The pixel value difference extractor 70 sets each pixel of the block supplied from the blocking unit 61 as a focused pixel. The pixel value difference extractor 70 calculates a pixel value difference d_{x,y}(=p_{x,y}−b_{x,y}), which is a difference between the pixel value p_{x,y} of the focused pixel and the first reference value b_{x,y} of the focused pixel supplied from the linear predictor 64. The pixel value difference extractor 70 supplies the pixel value difference d_{x,y} to the quantizer 71.

The quantizer 71 quantizes the pixel value difference d_{x,y} supplied from the pixel value difference extractor 70 on the basis of the quantization step Δ_{x,y} supplied from the quantization step size calculation unit 69. The quantizer 71 supplies quantized data Q_{x,y}(=d_{x,y}/Δ_{x,y}) resulting from the quantization to the output unit 72.

The output unit 72 multiplexes the quantized data Q_{x,y} supplied from the quantizer 71, the first representative values B of all blocks of the focused frame supplied from the block representative value calculation unit 62, and the second representative values T of all blocks of the focused frame supplied from the block representative value calculation unit 65. The output unit 72 then outputs the multiplexed data as coded data of the focused frame.

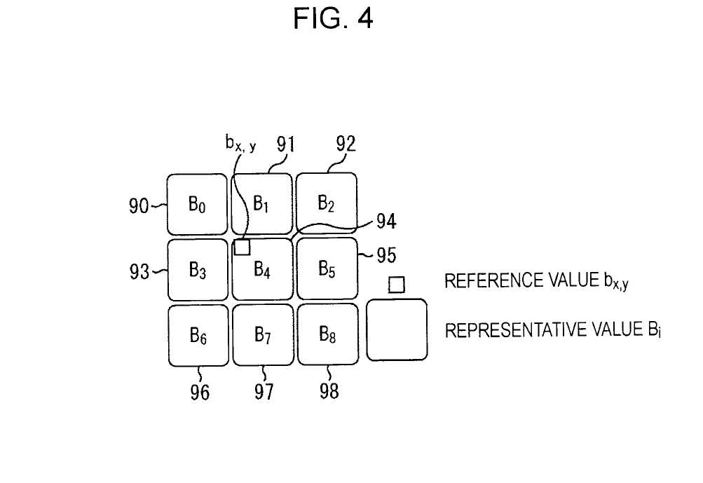

FIG. 4 illustrates a process performed by the linear predictor 64 shown in FIG. 3 to determine the first reference value b_{x,y} for the focused pixel using a linear operation (the first-order linear prediction).

More specifically, FIG. 4 shows nine blocks (3×3 in the vertical and horizontal directions) 90 to 98 among blocks constituting a focused frame.

Suppose that a given pixel in the block 94 among the blocks 90 to 98 shown in FIG. 4 is set as a focused pixel. The linear predictor 64 calculates the first reference value b_{x,y} of the focused pixel, for example, by performing a linear operation represented by Equation (1).

$${b}_{x , y} = {\sum }_{i}^{tap} {ω}_{bm , i} \cdot {B}_{i} \qquad ( 1 )$$

In Equation (1), Bᵢ is the first representative value of the (i+1)th block, among the 3×3 blocks 90 to 98 located around the block 94 including the focused pixel, in the raster scan order, whereas ω_{bm,i} is one of the first coefficients ω_{b} to be multiplied with the first representative value Bᵢ when the m-th pixel #m, among the pixels constituting the block, in the raster scan order is set as the focused pixel.

In addition, in Equation (1), tap is a value obtained by subtracting 1 from the number of the first representative values Bᵢ for use in determining the first reference value b_{x,y}. In the case of FIG. 4, the tap is equal to 8(=9−1). In this embodiment, nine first coefficients ω_{bm,0}, ω_{bm,1}, . . . , ω_{bm,8} to be multiplied with respective nine first representative values B₀ to B₈ are prepared as the first coefficient ω_{b} for each pixel #m constituting the respective block.

The block representative value calculation unit 62 calculates the first representative values B for all blocks, for example, as a solution of an integer programming problem.

More specifically, for example, the first representative value B is obtained as a solution of an integer programming problem when a function represented by Equation (3) is an objective function under the conditions represented by Equations (1) and (2).

$$\begin{matrix}{p}_{x , y} > {b}_{x , y} for {∀}_{x , y} & ( 2 ) \\ min : {\sum }_{x , y}^{all} ( {p}_{x , y} - {b}_{x , y} ) & ( 3 )\end{matrix}$$

Here, Equation (2) indicates that the first reference value b_{x,y} is a value not greater than the pixel values p_{x,y} of all pixels located at positions (x,y) of the focused frame.

In addition, Equation (3) indicates that a difference p_{x,y}−b_{x,y} between the pixel value p_{x,y} and the first reference value b_{x,y} is minimized regarding all pixels located at positions (x,y) of the focused frame.

Accordingly, the block representative value calculation unit 62 determines the first representative values B that are used in the linear operation for determining the first reference value b_{x,y} represented by Equation (1) and that minimize a sum of the differences p_{x,y}−b_{x,y} between the pixel values p_{x,y} and the first reference values b_{x,y} regarding all pixels of the focused frame.

The linear predictor 67 and the block representative value calculation unit 65 determine the second reference value t_{x,y} and the second representative value T in the same manner as the linear predictor 64 and the block representative value calculation unit 62, respectively.

Suppose that a given pixel included in the block 94, among the blocks 90 to 98 shown in FIG. 4, is set as the focused pixel. The linear predictor 67 calculates the second reference value t_{x,y} of the focused pixel, for example, by performing a linear operation represented by Equation (4).

$${t}_{x , y} = {\sum }_{i}^{tap} {ω}_{tm , i} \cdot {T}_{i} \qquad ( 4 )$$

In Equation (4), Tᵢ is the second representative value of the (i+1)th block, among the 3×3 blocks 90 to 98 located around the block 94 including the focused pixel, in the raster scan order, whereas ω_{tm,i} is one of the second coefficients ωₜ to be multiplied with the second representative value Tᵢ when the m-th pixel #m, among the pixels constituting the block, in the raster scan order is set as the focused pixel.

Additionally, in Equation (4), tap is a value obtained by subtracting 1 from the number of the second representative values Tᵢ for use in determining the second reference value t_{x,y}. In the case of FIG. 4, the tap is equal to 8(=9−1). In this embodiment, nine second coefficients ω_{tm,0}, ω_{tm,1}, . . . , ω_{tm,8} to be multiplied with respective nine second representative values T₀ to T₈ are prepared as the second coefficient ωₜ for each pixel #m constituting the block.

The block representative value calculation unit 65 calculates the second representative values T for all blocks, for example, as a solution of an integer programming problem.

More specifically, for example, the second representative value T is obtained as a solution of an integer programming problem when a function represented by Equation (6) is an objective function under the conditions represented by Equations (4) and (5).

$$\begin{matrix}{p}_{x , y} < {t}_{x , y} for {∀}_{x , y} & ( 5 ) \\ min : {\sum }_{x , y}^{all} ( {t}_{x , y} - {p}_{x , y} ) & ( 6 )\end{matrix}$$

Here, Equation (5) indicates that the second reference value t_{x,y} is a value not smaller than the pixel values p_{x,y} of all pixels located at positions (x,y) of the focused frame.

In addition, Equation (6) indicates that a difference t_{x,y}−p_{x,y} between the second reference value t_{x,y} and the pixel value p_{x,y} is minimized regarding all pixels located at positions (x,y) of the focused frame.

Accordingly, the block representative value calculation unit 65 determines the second representative values T that are used in the linear operation for determining the second reference value t_{x,y} represented by Equation (4) and that minimize a sum of the differences t_{x,y}−p_{x,y} between the pixel values p_{x,y} and the second reference values t_{x,y} of all pixels of the focused frame.

The reference value difference D_{x,y}=t_{x,y}−b_{x,y}, which is a difference between the second reference value t_{x,y} and the first reference value b_{x,y} determined by the reference value difference extractor 68, is represented as a sum of the difference p_{x,y}−b_{x,y} between the pixel value p_{x,y} and the first reference value b_{x,y} and the difference t_{x,y}−p_{x,y} between the second reference value t_{x,y} and the pixel value p_{x,y}, as represented by Equation (7).

D_{x,y}=(p_{x,y}−b_{x,y})+(t_{x,y}−p_{x,y}) (7)

Accordingly, the first reference value b_{x,y}, which is determined based on the first representative value B that minimizes the difference p_{x,y}−b_{x,y} between the pixel value p_{x,y} and the first reference value b_{x,y} as represented by Equation (3), and the second reference value t_{x,y}, which is determined based on the second representative value T that minimizes difference t_{x,y}−p_{x,y} between the second reference value t_{x,y} and the pixel value p_{x,y} as represented by Equation (6), minimize the sum of the reference value differences D_{x,y} determined from the first reference values b_{x,y} and the second reference values t_{x,y} as represented by Equation (8).

$${\sum }_{x , y}^{all} {D}_{x , y} -> min \qquad ( 8 )$$

Hereinafter, the first reference value b_{x,y} that is not greater than the pixel value p_{x,y} and (is determined based on the first representative value B that) minimizes the difference p_{x,y}−b_{x,y} between the pixel value p_{x,y} ad the first reference value b_{x,y} is referred to as an optimized first reference value b_{x,y}. Similarly, hereinafter, the second reference value t_{x,y} that is not smaller than the pixel value p_{x,y} and (is determined based on the second representative value T that) minimizes the difference t_{x,y}−p_{x,y} between the second reference value t_{x,y} and the pixel value p_{x,y} is referred to as an optimized second reference value t_{x,y}.

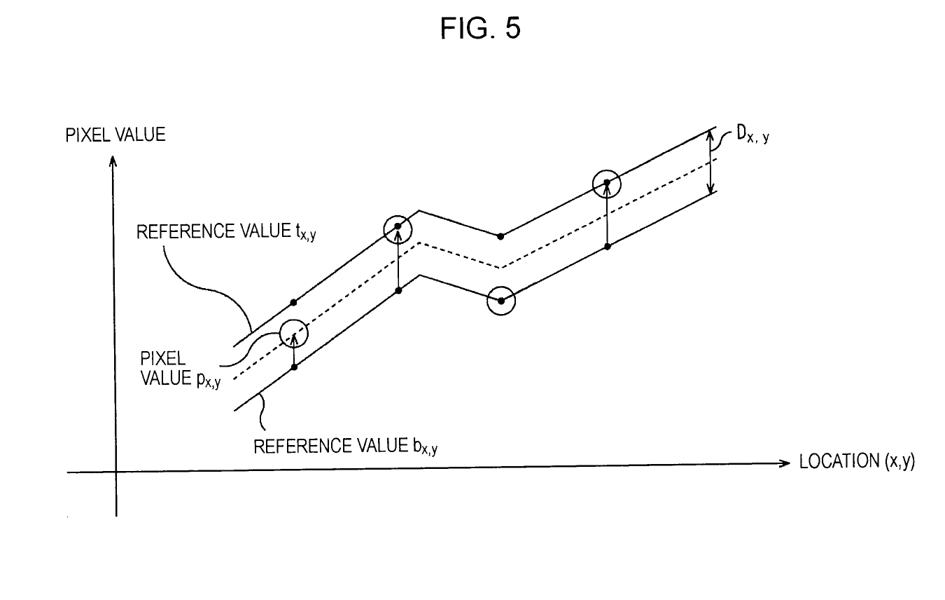

FIG. 5 shows the optimized first and second reference values b_{x,y} and t_{x,y}.

Referring to FIG. 5, the horizontal axis represents a location (x,y) of a pixel, wherein the vertical axis represents a pixel value.

In ADRC according to the related art, a minimum pixel value MIN and a maximum pixel value MAX of a block are employed as the first reference value b_{x,y} and the second reference value t_{x,y}, respectively. The first reference value b_{x,y} and the second reference value t_{x,y} are constant for pixels included in the block. However, the first reference value b_{x,y} and the second reference value t_{x,y} differ for each pixel of the block in coding performed by the coding apparatus 31 shown in FIG. 3. As a result, the reference value difference D_{x,y} also differs for each pixel of the block.

As described above, the first reference value b_{x,y} is a value that minimizes the difference p_{x,y}−b_{x,y} between the pixel value p_{x,y} and the first reference value b_{x,y} and is not greater than the pixel value p_{x,y}. Additionally, the second reference value t_{x,y} is a value that minimizes the difference t_{x,y}−p_{x,y} between the second reference value t_{x,y} and the pixel value p_{x,y} and is not smaller than the pixel value p_{x,y}. Therefore, the reference value difference D_{x,y} determined from such first and second reference values b_{x,y} and t_{x,y} becomes smaller than the ADRC dynamic range DR according to the related art determined based on the minimum pixel value MIN and the maximum pixel value MAX of the block.

Accordingly, the quantization step Δ_{x,y} determined based on such a reference value difference D_{x,y} also becomes smaller than that of the ADRC according to the related art. As a result, a quantization error can be reduced.

Furthermore, the first reference value b_{x,y} that is subtracted from the pixel value p_{x,y} at the time of determination of the pixel value difference d_{x,y} is a value that minimizes the difference p_{x,y}−b_{x,y} between the pixel value p_{x,y} and the first reference value b_{x,y}. That is, the first reference value b_{x,y} is a value closer to the pixel value p_{x,y} (a minimum pixel value of the block). Thus, in that respect, the quantization error can be reduced than in the ADRC according to the related art.

Referring to a flowchart shown in FIG. 6, a coding process performed by the coding apparatus 31 shown in FIG. 3 will now be described.

At STEP S31, the blocking unit 61 sets supplied image data of one frame as a focused frame and divides the focused frame into a plurality of blocks. The blocking unit 61 supplies the blocks of the focused frame to the block representative value calculation units 62 and 65 and the pixel value difference extractor 70. The process then proceeds to STEP S32 from STEP S31.

At STEP S32, the block representative value calculation unit 62 calculates, for each block constituting the focused frame supplied from the blocking unit 61, the first representative value B that satisfies Equations (1) to (3) using the first coefficient ω_{b} stored in the storage unit 63. The block representative value calculation unit 62 then supplies the determined first representative value B to the linear predictor 64 and the output unit 72. The process then proceeds to STEP S33.

At STEP S33, the block representative value calculation unit 65 calculates, for each block constituting the focused frame supplied from the blocking unit 61, the second representative value T that satisfies Equations (4) to (6) using the second coefficient ωₜ stored in the storage unit 66. The block representative value calculation unit 65 then supplies the determined second representative value T to the linear predictor 67 and the output unit 72. The process then proceeds to STEP S34.

At STEP S34, the linear predictor 64 stores the first representative values B for all blocks of the focused frame supplied from the block representative value calculation unit 62 in the memory 64a included therein.

Additionally, at STEP S34, the linear predictor 64 performs a linear operation represented by Equation (1) using the first representative values Bᵢ of the focused block and the surrounding blocks stored in the memory 64a and the first coefficient ω_{b} stored in the storage unit 63 while sequentially setting each block of the focused frame as a focused block and each pixel of the focused block as a focused pixel. The linear predictor 64 supplies the first reference value b_{x,y} of the focused pixel resulting from the linear operation to the reference value difference extractor 68 and the pixel value difference extractor 70. The process then proceeds to STEP S35.

At STEP S35, the linear predictor 67 stores the second representative values T for all blocks of the focused frame supplied from the block representative value calculation unit 65 in the memory 67a included therein.

Additionally, at STEP S35, the linear predictor 67 performs a linear operation represented by Equation (4) using the second representative values Tᵢ of the focused block and the surrounding blocks stored in the memory 67a and the second coefficient ωₜ stored in the storage unit 66. The linear predictor 67 supplies the second reference value t_{x,y} of the focused pixel resulting from the linear operation to the reference value difference extractor 68. The process then proceeds to STEP S36.

At STEP S36, the reference value difference extractor 68 calculates, regarding the focused pixel, the reference value difference D_{x,y}, which is a difference between the second reference value t_{x,y} supplied from the linear predictor 67 and the first reference value b_{x,y} supplied from the linear predictor 64. The reference value difference extractor 68 supplies the reference value difference D_{x,y} to the quantization step size calculation unit 69. The process then proceeds to STEP S37.

At STEP S37, the quantization step size calculation unit 69 calculates, on the basis of the reference value difference D_{x,y} supplied from the reference value difference extractor 68, the quantization step Δ_{x,y} with which the pixel value p_{x,y} of the focused pixel is quantized. The quantization step size calculation unit 69 supplies the quantization step Δ_{x,y} to the quantizer 71. The process then proceeds to STEP S38.

At STEP S38, the pixel value difference extractor 70 calculates the pixel value difference d_{x,y}, which is a difference between the pixel value p_{x,y} of the focused pixel of the focused block among the blocks supplied from the blocking unit 61 and the first reference value b_{x,y} of the focused pixel supplied from the linear predictor 64. The pixel value difference extractor 70 supplies the pixel value difference d_{x,y} to the quantizer 71. The process then proceeds to STEP S39.

At STEP S39, the quantizer 71 quantizes the pixel value difference d_{x,y} supplied from the pixel value difference extractor 70 on the basis of the quantization step Δ_{x,y} supplied from the quantization step size calculation unit 69. The quantizer 71 supplies quantized data Q_{x,y}(=d_{x,y}/Δ_{x,y}) resulting from the quantization to the output unit 72.

The processing of STEPs S34 to S39 is performed while setting every pixel of the focused frame as the focused pixel and the quantized data Q_{x,y} is obtained regarding all pixels of the focused frame. Thereafter, the process proceeds to STEP S40 from STEP S39.

At STEP S40, the output unit 72 multiplexes the quantized data Q_{x,y} of all pixels of the focused frame supplied from the quantizer 71, the first representative values B for respective blocks of the focused frame supplied from the block representative value calculation unit 62, and the second representative values T for respective blocks of the focused frame supplied from the block representative value calculation unit 65 to create coded date of the focused frame and outputs the coded data. The process then proceeds to STEP S41.

At STEP S41, the linear predictor 64 determines whether the process is completed regarding all coding-target image data.

If it is determined that the process is not completed regarding all coding-target image data at STEP S41, the process returns to STEP S31. At STEP S31, the blocking unit 61 sets a supplied new frame as the focused frame and repeats the similar processing.

On the other hand, if it is determined that the process is completed regarding all coding-target image data at STEP S41, the coding process is terminated.

According to the coding process shown in FIG. 6, the first representative value B that minimizes the sum of the differences p_{x,y}−b_{x,y} and the second representative value T that minimizes the sum of the differences t_{x,y}−p_{x,y} are determined as shown by Equations (3) and (6), respectively. Accordingly, the reference value difference D_{x,y} represented by Equation (7) can be made smaller and the quantization step Δ_{x,y} proportional to the reference value difference D_{x,y} can also be made smaller.

As a result, the quantization error can be reduced.

Furthermore, in the coding process shown in FIG. 6, the pixel value difference extractor 70 uses the first reference value b_{x,y} that minimizes the difference p_{x,y}−b_{x,y} between the pixel value p_{x,y} and the first reference value b_{x,y}, namely, the first reference value b_{x,y} closer to the pixel value p_{x,y}, as the first reference value b_{x,y} based on which the difference from the pixel value p_{x,y} is determined. Thus, the quantization error can be reduced.

In the ADRC according to the related art, the quantized data resulting from quantization of pixel values and two of the minimum value MIN, the maximum value MAX, and the dynamic range DR for each block are converted into coded data of the block. On the other hand, in the process shown in FIG. 6, the quantized data resulting from quantization of pixel values and the first and second representative values B and T for each block are converted into the coded data of the block.

Thus, according to the coding process shown in FIG. 6, the quantization error can be reduced than in the ADRC according to the related art without increasing an amount of the coded data.

FIG. 7 is a block diagram showing a first configuration example of the decoding apparatus 32 shown in FIG. 2.

The decoding apparatus 32 shown in FIG. 7 includes an input unit 101, a storage unit 102, a linear predictor 103 including a memory 103a, a storage unit 104, a linear predictor 105 including a memory 105a, a reference value difference extractor 106, a quantization step size calculation unit 107, a dequantizer 108, an adder 109, and a tiling unit 110.

The coded data including the first representative values B, the second representative values T, and the quantized data Q_{x,y} output from the coding apparatus 31 shown in FIG. 3 is supplied to the input unit 101, for example, through the recording medium 33 or the transmission medium 34 (see FIG. 2). At this time, the coded data is input (supplied), for example, in a unit of one frame.

The input unit 101 sets the supplied coded data of one frame as coded data of a focused frame. The input unit 101 demultiplexes the coded data into the first representative values B for all blocks of the focused frame, the second representative values T for all blocks of the focused frame, and the quantized data Q_{x,y} of each pixel of the focused frame. The input unit 101 then inputs the second representative values T, the first representative values B, and the quantized data Q_{x,y} to the linear predictor 103, the linear predictor 105, and the dequantizer 108, respectively.

The storage unit 102 stores a second coefficient ωₜ, which is the same as the second coefficient ωₜ stored in the storage unit 66 shown in FIG. 3.

The linear predictor 103 stores the second representative values T for all blocks of the focused frame supplied from the input unit 101 in the memory 103a included therein.

The linear predictor 103 performs processing similar to that performed by the linear predictor 67 shown in FIG. 3 using the second representative values T stored in the memory 103a and the second coefficient ωₜ stored in the storage unit 102 to determine a second reference value t_{x,y}, which is the same as the second reference value t_{x,y} output by the linear predictor 67 shown in FIG. 3. The linear predictor 103 supplies the second reference value t_{x,y} to the reference value difference extractor 106.

The storage unit 104 stores a first coefficient ω_{b}, which is the same as the first coefficient ω_{b} stored in the storage unit 63 shown in FIG. 3.

The linear predictor 105 stores the first representative values B for all blocks of the focused frame supplied from the input unit 101 in the memory 105a included therein.

The linear predictor 105 performs processing similar to that performed by the linear predictor 64 shown in FIG. 3 using the first representative values B stored in the memory 105a and the first coefficient ω_{b} stored in the storage unit 104 to determine a first reference value b_{x,y}, which is the same as the first reference value b_{x,y} output by the linear predictor 64 shown in FIG. 3. The linear predictor 105 supplies the first reference value b_{x,y} to the reference value difference extractor 106 and the adder 109.

As in the case of the reference value difference extractor 68 shown in FIG. 3, the reference value difference extractor 106 calculates a reference value difference D_{x,y} between the second reference value t_{x,y} supplied from the linear predictor 103 and the first reference value b_{x,y} supplied from the linear predictor 105. The reference value difference extractor 106 supplies the reference value difference D_{x,y} to the quantization step size calculation unit 107.

As in the case of the quantization step size calculation unit 69 shown in FIG. 3, the quantization step size calculation unit 107 calculates, on the basis of the reference value difference D_{x,y} supplied from the reference value difference extractor 106, a quantization step Δ_{x,y} with which the quantized data Q_{x,y} supplied from the input unit 101 to the dequantizer 108 is dequantized. The quantization step size calculation unit 107 supplies the quantization step Δ_{x,y} to the dequantizer 108. The quantization step size calculation unit 107 is supplied with the number of quantization bits n, which is the same as that supplied to the quantization step size calculation unit 69 shown in FIG. 3, from a circuit (not shown). The quantization step Δ_{x,y} is calculated according to an equation Δ_{x,y}=D_{x,y}/2ⁿ.

The dequantizer 108 dequantizes the quantized data Q_{x,y} supplied from the input unit 101 on the basis of the quantization step Δ_{x,y} supplied from the quantization step size calculation unit 107. The dequantizer 108 then supplies the pixel value difference d_{x,y}(=p_{x,y}−b_{x,y}) resulting from the dequantization to the adder 109.

The adder 109 adds the first reference value b_{x,y} supplied from the linear predictor 105 and the pixel value difference d_{x,y} supplied from the dequantizer 108. The adder 109 supplies the sum p_{x,y} resulting from the addition to the tiling unit 110 as the decoded result.

The tiling unit 110 performs tiling of the sum p_{x,y} serving as the decoded result of each pixel of the focused frame supplied from the adder 109 to create decoded image data of the focused frame and outputs the decoded image data to a display, not shown.

A decoding process performed by the decoding apparatus 32 shown in FIG. 7 will now be described with reference to a flowchart shown in FIG. 8.

At STEP S61, the input unit 101 sets supplied coded data of one frame as coded data of a focused frame. The input unit 101 demultiplexes the coded data of the focused frame into the first representative values B, the second representative values T, and the quantized data Q_{x,y}. The input unit 101 inputs the second representative values T of all blocks of the focused frame, the first representative values B of all blocks of the focused frame, and the quantized data Q_{x,y} of each pixel of the focused frame to the linear predictor 103, the linear predictor 105, and the dequantizer 108, respectively. The process then proceeds to STEP S62.

At STEP S62, the linear predictor 105 stores the first representative values B of all blocks of the focused frame supplied from the input unit 101 in the memory 105a included therein.

In addition, at STEP S62, the linear predictor 105 performs processing similar to that performed by the linear predictor 64 shown in FIG. 3 using the first representative values B stored in the memory 105a and the first coefficient ω_{b} stored in the storage unit 104 while sequentially setting each pixel of the focused frame as the focused pixel to determine the first reference value b_{x,y}, which is the same as the first reference value b_{x,y} output by the linear predictor 64 shown in FIG. 3. The linear predictor 105 supplies the first reference value b_{x,y} to the reference value difference extractor 106 and the adder 109. The process then proceeds to STEP S63.

At STEP S63, the linear predictor 103 stores the second representative values T of all blocks of the focused frame supplied from the input unit 101 in the memory 103a included therein.

In addition, at STEP S63, the linear predictor 103 performs processing similar to that performed by the linear predictor 67 shown in FIG. 3 using the second representative values T stored in the memory 103a and the second coefficient ωₜ stored in the storage unit 102 to determine the second reference value t_{x,y}, which is the same as the second reference value t_{x,y} output by the linear predictor 67 shown in FIG. 3. The linear predictor 103 supplies the second reference value t_{x,y} to the reference value difference extractor 106. The process then proceeds to STEP S64.

At STEP S64, as in the case of the reference value difference extractor 68 shown in FIG. 3, the reference value difference extractor 106 calculates, regarding the focused pixel, the reference value difference D_{x,y} between the second reference value t_{x,y} supplied from the linear predictor 103 and the first reference value b_{x,y} supplied from the linear predictor 105. The reference value difference extractor 106 supplies the reference value difference D_{x,y} to the quantization step size calculation unit 107. The process then proceeds to STEP S65.

At STEP S65, as in the case of the quantization step size calculation unit 69 shown in FIG. 3, the quantization step size calculation unit 107 calculates, on the basis of the reference value difference D_{x,y} supplied from the reference value difference extractor 106, a quantization step Δ_{x,y} with which the quantized data Q_{x,y} of the focused pixel to be supplied to the dequantizer 108 from the input unit 101 is dequantized. The quantization step size calculation unit 107 supplies the quantization step Δ_{x,y} to the dequantizer 108. The process then proceeds to STEP S66.

At STEP S66, the dequantizer 108 dequantizes the quantized data Q_{x,y} of the focused pixel supplied from the input unit 101 on the basis of the quantization step Δ_{x,y} supplied from the quantization step size calculation unit 107. The dequantizer 108 supplies the pixel value difference d_{x,y} of the focused pixel resulting from the dequnatization to the adder 109. The process then proceeds to STEP S67.

At STEP S67, the adder 109 adds the first reference value b_{x,y} of the focused pixel supplied from the linear predictor 105 and the pixel value difference d_{x,y} of the focused pixel supplied from the dequantizer 108. The adder 109 supplies the sum p_{x,y} resulting from the addition to the tiling unit 110 as a decoded result of the focused pixel.

The processing of STEPs S62 to S67 is performed while sequentially setting every pixel of the focused frame as the focused pixel and the sum p_{x,y} is obtained regarding all pixels of the focused frame as the decoded result. Thereafter, the process proceeds to STEP S68 from STEP S67.

At STEP S68, the tiling unit 110 performs tiling of sum p_{x,y} serving as the decoded result of each pixel of the focused frame supplied from the adder 109 to create decoded image data of the focused frame and outputs the decoded image data to a display (not shown). The process then proceeds to STEP S69.

At STEP S69, the linear predictor 105 determines whether the process is completed regarding all decoding-target coded data.

If it is determined that the process is not completed regarding all decoding-target coded data at STEP S69, the process returns to STEP S61. At STEP S61, the input unit 101 repeats the similar processing while setting a supplied coded data of a new frame as coded data of a new focused frame.

On the other hand, if it is determined that the process is completed regarding all decoding-target coded data at STEP S69, the decoding process is terminated.

In the decoding process shown in FIG. 8, since the quantization step Δ_{x,y} is calculated on the basis of the reference value difference D_{x,y} that is minimized by the coding apparatus 31 shown in FIG. 3, the quantization step Δ_{x,y} proportional to the reference value difference D_{x,y} can be made smaller. Accordingly, the quantization error resulting from the dequnatization can be reduced, which can improve the S/N ratio of the decoded image data and can provide decoded image data having a preferable gradation part or the like.

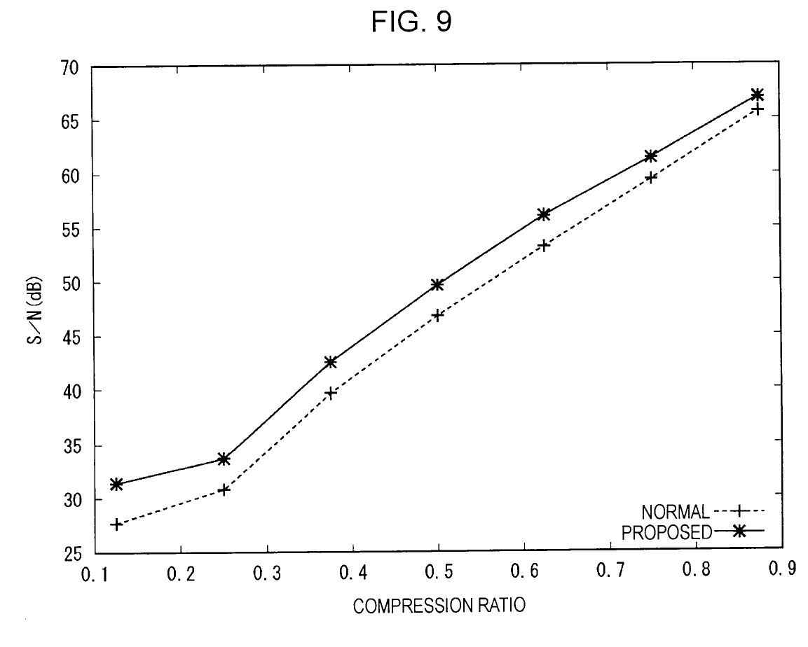

FIG. 9 shows a relation between an S/N ratio of decoded image data and a data compression ratio resulting from a simulation.

Referring to FIG. 9, the horizontal axis represents a compression ratio(=[an amount of coded data]/[an amount of original image data]), whereas the vertical axis represents an S/N ratio of decoded image data.

In FIG. 9, a solid line represents the S/N ratio of the decoded image data obtained by the decoding apparatus 32 shown in FIG. 7 decoding coded data of an image compressed at a predetermined compression ratio by the coding apparatus 31 shown in FIG. 3. In addition, a broken line represents the S/N ratio of the decoded image data obtained by decoding coded data compressed at a predetermined compression ratio using the ADRC according to the related art.

FIG. 9 reveals that the S/N ratio of the image data decoded by the decoding apparatus 32 shown in FIG. 7 is improved than the S/N ratio of the image data decoded using the ADRC according to the related art.

FIG. 10 is a block diagram showing a second configuration example of the coding apparatus 31 shown in FIG. 2.

In FIG. 10, similar or like numerals are attached to elements common to those shown in FIG. 3 and a description thereof is omitted.

More specifically, the coding apparatus 31 shown in FIG. 10 is configured in a manner similar to that shown in FIG. 3 except for including a minimum-value-in-block detector 151, a coefficient calculation unit 152, a linear predictor 153 including a memory 153a, a maximum-value-in-block detector 154, a coefficient calculation unit 155, a linear predictor 156 including a memory 156a, and an output unit 157 instead of the block representative value calculation unit 62 to the linear predictor 67 and the output unit 72.

The minimum-value-in-block detector 151 is supplied with blocks of a focused frame by a blocking unit 61. The minimum-value-in-block detector 151 detects a minimum pixel value of a focused block while sequentially setting each block of the focused frame supplied from the blocking unit 61 as the focused block. The minimum-value-in-block detector 151 supplies the minimum value to the coefficient calculation unit 152, the linear predictor 153, and the output unit 157 as the first representative value B of the block.

The coefficient calculation unit 152 calculates, on the basis of the first representative values B of all blocks of the focused frame supplied from the minimum-value-in-block detector 151, a first coefficient ω_{b} used to determine a first reference value b_{x,y} along with the first representative values B. The coefficient calculation unit 152 supplies the first coefficient ω_{b} to the linear predictor 153 and the output unit 157.

More specifically, referring back to FIG. 3, the block representative value calculation unit 62 determines the first representative value Bᵢ that satisfies Equations (1) to (3) while assuming that the first representative value Bᵢ and the first coefficient ω_{bm,i} of Equation (1) are unknown and known, respectively. Referring to FIG. 10, the coefficient calculation unit 152 employs the minimum value of the block, which is already known, as the first representative value Bᵢ of Equation (1) and determines the unknown first coefficient ω_{bm,i} that satisfies Equations (1) to (3) for each pixel #m of the block of the focused frame.

The linear predictor 153 stores the first representative values B of all blocks of the focused frame supplied from the minimum-value-in-block detector 151 and the first coefficient ω_{b} for each pixel of the block of the focused frame supplied from the coefficient calculation unit 152 in the memory 153a included therein.

The linear predictor 153 performs a linear operation represented by Equation (1) using the first representative value B and the first coefficient ω_{b} stored in the memory 153a. The linear predictor 153 then supplies the first reference value b_{x,y}, not greater than the pixel value p_{x,y} of the focused pixel, resulting from the linear operation to the reference value difference extractor 68 and the pixel value difference extractor 70.

The maximum-value-in-block detector 154 is supplied with the blocks of the focused frame by the blocking unit 61. The maximum-value-in-block detector 154 detects a maximum pixel value of the focused block while setting each block of the focused frame supplied from the blocking unit 61 as the focused block. The maximum-value-in-block detector 154 supplies the maximum value to the coefficient calculation unit 155, the linear predictor 156, and the output unit 157 as a second representative value T of the block.

The coefficient calculation unit 155 calculates, on the basis of the second representative values T of all blocks of the focused frame supplied from the maximum-value-in-block detector 154, a second coefficient ωₜ used to determine a second reference value t_{x,y} along with the second representative values T. The coefficient calculation unit 155 supplies the second coefficient ωₜ to the linear predictor 156 and the output unit 157.

More specifically, referring back to FIG. 3, the block representative value calculation unit 65 determines the second representative value Tᵢ that satisfies Equations (4) to (6) while assuming that the second representative value Tᵢ and the second coefficient ω_{tm,i} of Equation (4) are unknown and known, respectively. Referring to FIG. 10, the coefficient calculation unit 155 employs the maximum value of the block, which is already known, as the second representative value Tᵢ of Equation (4) and determines the unknown second coefficient ω_{tm,i} that satisfies Equations (4) to (6) for each pixel #m of the block of the focused frame.

The linear predictor 156 stores the second representative values T of all blocks of the focused frame supplied from the maximum-value-in-block detector 154 and the second coefficient ωₜ for each pixel of the block of the focused frame supplied from the coefficient calculation unit 155 in the memory 156a included therein.

The linear predictor 156 performs a linear operation represented by Equation (4) using the second representative value T and the second coefficient ωₜ stored in the memory 156a. The linear predictor 156 then supplies the second reference value t_{x,y}, not smaller than the pixel value p_{x,y} of the focused pixel, resulting from the linear operation to the reference value difference extractor 68.

The output unit 157 is supplied with quantized data Q_{x,y} of each pixel of the focused frame from the quantizer 71.

The output unit 157 multiplexes the quantized data Q_{x,y} of each pixel of the focused frame supplied from the quantizer 71, the first representative value B that is the minimum value of each block of the focused frame supplied from the minimum-value-in-block detector 151, the second representative value T that is the maximum value of each block of the focused frame supplied from the maximum-value-in-block detector 154, the first coefficient ω_{b} determined for each pixel of the block of the focused frame supplied from the coefficient calculation unit 152, and the second coefficient ωₜ determined for each pixel of the block of the focused frame supplied from the coefficient calculation unit 155, and outputs the multiplexed data as coded data of the focused frame.

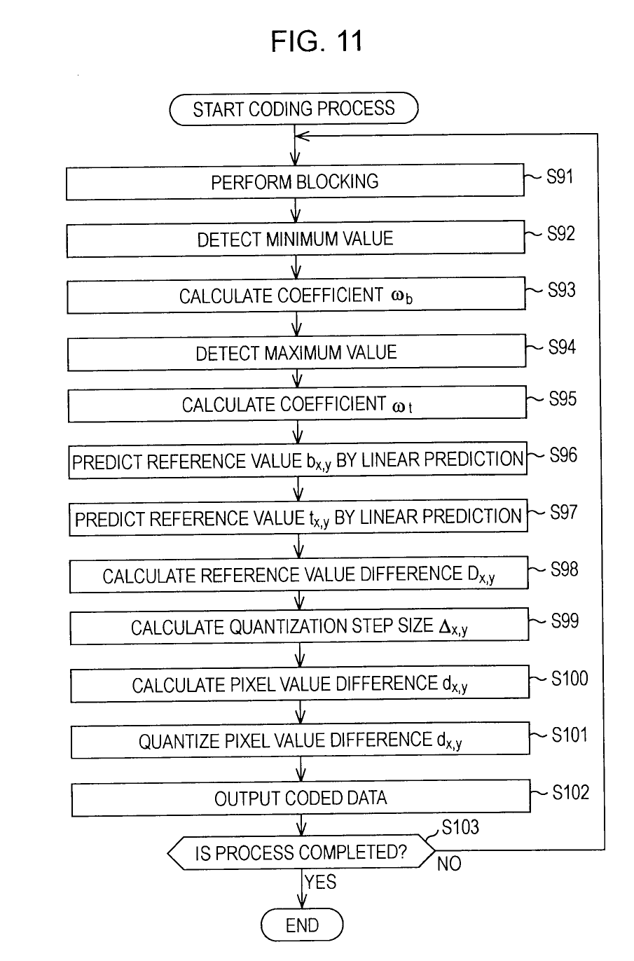

A coding process performed by the coding apparatus 31 shown in FIG. 10 will now be described with reference to a flowchart shown in FIG. 11.

At STEP S91, processing similar to that of STEP S31 shown in FIG. 6 is performed. The process then proceeds to STEP S92. At STEP S92, the minimum-value-in-block detector 151 detects the minimum pixel value of the focused block while sequentially setting each block of the focused frame supplied from the blocking unit 61 as the focused block. The minimum-value-in-block detector 151 supplies the minimum value to the coefficient calculation unit 152, the linear predictor 153, and the output unit 157 as the first representative value B of the block. The process then proceeds to STEP S93.

At STEP S93, the coefficient calculation unit 152 calculates, on the basis of the first representative values B of all blocks of the focused frame supplied from the minimum-value-in-block detector 151, the first coefficient ω_{b} used to determine the first reference value b_{x,y} along with the first representative values B. The coefficient calculation unit 152 supplies the first coefficient ω_{b} to the linear predictor 153 and the output unit 157. The process proceeds to STEP S94.

At STEP S94, the maximum-value-in-block detector 154 detects the maximum pixel value of the focused block while sequentially setting each block of the focused frame supplied from the blocking unit 61 as the focused block. The maximum-value-in-block detector 154 supplies the maximum value to the coefficient calculation unit 155, the linear predictor 156, and the output unit 157 as the second representative value T of the block. The process then proceeds to STEP S95.

At STEP S95, the coefficient calculation unit 155 calculates, on the basis of the second representative values T of all blocks of the focused frame supplied from the maximum-value-in-block detector 154, the second coefficient ωₜ used to determine the second reference value t_{x,y} along with the second representative values T. The coefficient calculation unit 155 supplies the second coefficient ωₜ to the linear predictor 156 and the output unit 157. The process proceeds to STEP S96.

At STEP S96, the linear predictor 153 stores the first representative values B of all blocks of the focused frame supplied from the minimum-value-in-block detector 151 and the first coefficient ω_{b} for each pixel of block supplied from the coefficient calculation unit 152 in the memory 153a included therein while sequentially setting each block of the focused frame as the focused frame and each pixel of the focused block as the focused pixel.

In addition, at STEP S96, the linear predictor 153 performs a linear operation represented by Equation (1) using the first representative values B and the first coefficient ω_{b} stored in the memory 153a. The linear predictor 153 supplies the first reference value b_{x,y} not greater than the pixel value p_{x,y} of the focused pixel, resulting from the linear operation to the reference value difference extractor 68 and the pixel value difference extractor 70. The process then proceeds to STEP S97.

At STEP S97, the linear predictor 156 stores the second representative values T of all blocks of the focused frame supplied from the maximum-value-in-block detector 154 and the second coefficient ωₜ of each pixel of the block supplied from the coefficient calculation unit 155 in the memory 156a included therein.

In addition, at STEP S97, the linear predictor 156 performs a linear operation represented by Equation (4) using the second representative values T and the second coefficient ωₜ stored in the memory 156a. The linear predictor 156 supplies the second reference value t_{x,y}, not smaller than the pixel value p_{x,y} of the focused pixel, resulting from the linear operation to the reference value difference extractor 68.

After the processing of STEP S97, the process proceeds to STEP S98. At STEPs S98 to S101, processing similar to that of STEPs S36 to S39 shown in FIG. 6 is performed.

The processing of STEPs S96 to S101 is performed while setting every pixel of the focused frame as the focused pixel and quantized data Q_{x,y} for all pixels of the focused frame is obtained. The process then proceeds to STEP S102 from STEP S101.

At STEP S102, the output unit 157 multiplexes the quantized data Q_{x,y} of each pixel of the focused frame supplied from the quantizer 71, the first reference value B that is the minimum value of each block of the focused frame supplied from the minimum-value-in-block detector 151, the second representative value T that is the maximum value of each block of the focused frame supplied from the maximum-value-in-block detector 154, the first coefficient ω_{b} determined for each pixel of the block of the focused frame supplied from the coefficient calculation unit 152, and the second coefficient ωₜ determined for each pixel of the block of the focused frame supplied from the coefficient calculation unit 155 to create coded data of the focused frame. The output unit 157 outputs the coded data of the focused frame.

After the processing of STEP S102, the process proceeds to STEP S103. The linear predictor 153 determines whether the process is completed regarding all coding-target image data.

If it is determined that the process is not completed regarding all coding-target image data at STEP S103, the process returns to STEP S91. At STEP S91, the blocking unit 61 repeats the similar processing while setting supplied coded data of a new frame as coded data of a new focused frame.

On the other hand, if it is determined that the process is completed regarding all coding-target image data at STEP S103, the coding process is terminated.

According to the coding process shown in FIG. 11, the first coefficient ω_{b} that minimizes the sum of the differences p_{x,y}−b_{x,y} and the second coefficient ωₜ that minimizes the sum of the differences t_{x,y}−p_{x,y} are determined as represented by Equations (3) and (6), respectively. Accordingly, the reference value difference D_{x,y} represented by Equation (7) can be made smaller and the quantization step Δ_{x,y} that is proportional to the reference value difference D_{x,y} can also be made smaller.

As a result, a quantization error can be reduced.

Furthermore, the pixel value difference extractor 70 uses the first reference value b_{x,y} that minimizes the difference p_{x,y}−b_{x,y} between the pixel value p_{x,y} and the first reference value b_{x,y}, namely, the first reference value b_{x,y} closer to the pixel value p_{x,y}, as the first reference value b_{x,y} based on which the difference from the pixel value p_{x,y} is determined in the coding process shown in FIG. 11. Thus, the quantization error can be reduced.

FIG. 12 is a block diagram showing a second configuration example of the decoding apparatus 32 shown in FIG. 2.

In FIG. 12, similar or like numerals are attached to elements common to those shown in FIG. 7 and a description thereof is omitted.

More specifically, the decoding apparatus 32 shown in FIG. 12 is configured in a manner similar to that of FIG. 7 expect for including an input unit 191, a linear predictor 192 including a memory 192a, a linear predictor 193 including a memory 193a instead of the input unit 101, the storage unit 102 and the linear predictor 103, and the storage unit 104 and the linear predictor 105.

Coded data including the first representative value B, the second representative value T, the first coefficient ω_{b}, the second coefficient ωₜ, and the quantized data Q_{x,y} output from the coding apparatus 31 shown in FIG. 10 is input to the input unit 191, for example, through the recording medium 33 or the transmission medium 34. At this time, the coded data is input, for example, in a unit of one frame.

The input unit 191 sets supplied coded data of one frame as coded data of a focused frame. The input unit 191 demultiplexes the coded data into the first representative values B and the second representative values T for all blocks of the focused frame, the first coefficient ω_{b} and the second coefficient ωₜ of each pixel of the block of the focused frame, and the quantized data Q_{x,y} of each pixel of the focused frame. The input unit 191 then inputs the second representative values T and the second coefficient ωₜ, the first representative value B and the first coefficient ω_{b}, and the quantized data Q_{x,y} to the linear predictor 192, the linear predictor 193, and the dequantizer 108, respectively.

The linear predictor 192 stores the second representative values T of all blocks of the focused frame and the second coefficient ω_{b} of each pixel of the block of the focused frame supplied from the input unit 191 in the memory 192a included therein.

The linear predictor 192 performs processing similar to that performed by the linear predictor 156 shown in FIG. 10 using the second representative values T and the second coefficient ωₜ stored in the memory 192a to determine a second reference value t_{x,y}, which is the same as the second reference value t_{x,y} output by the linear predictor 156 shown in FIG. 10. The linear predictor 192 supplies the second reference value t_{x,y} to the reference value difference extractor 106.

The linear predictor 193 stores the first representative values B of all blocks of the focused frame and the first coefficient ω_{b} of each pixel of the block of the focused frame supplied from the input unit 191 in the memory 193a included therein.

The linear predictor 193 performs processing similar to that performed by the linear predictor 153 shown in FIG. 10 using the first representative values B and the first coefficient ω_{b} stored in the memory 193a to determine a first reference value b_{x,y}, which is the same as the first reference value b_{x,y} output by the linear predictor 153 shown in FIG. 10. The linear predictor 193 supplies the first reference value b_{x,y} to the reference value difference extractor 106 and the adder 109.

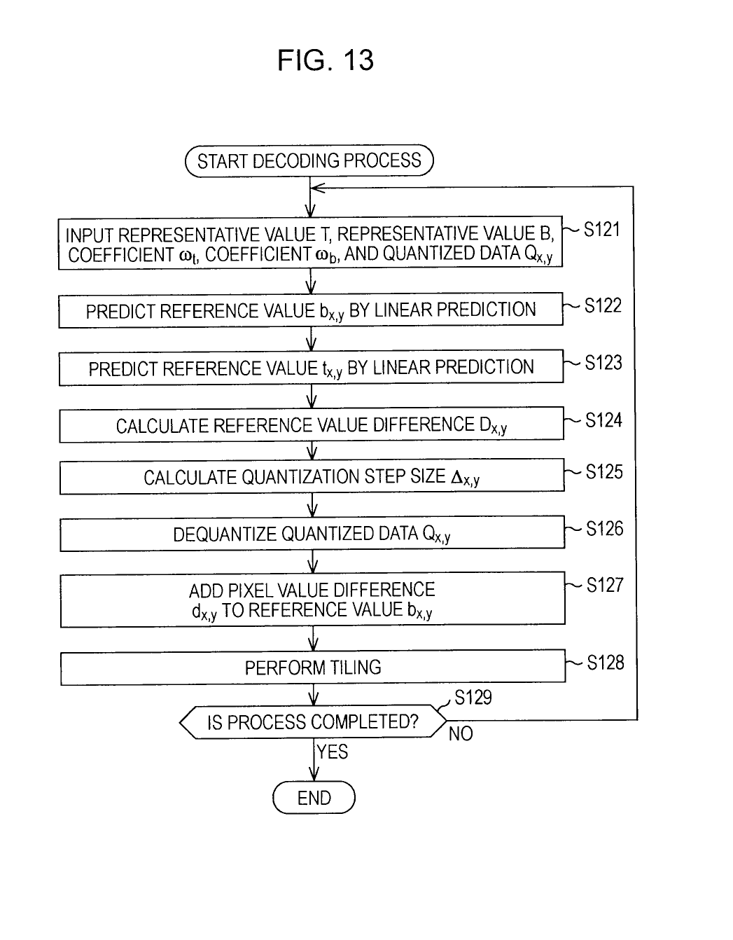

A decoding process performed by the decoding apparatus 32 shown in FIG. 12 will now be described with reference to a flowchart shown in FIG. 13.

At STEP S121, the input unit 191 sets supplied coded data of one frame as coded data of a focused frame. The input unit 191 demultiplexes the coded data into the first representative values B and the second representative values T for all blocks of the focused frame, the first coefficient ω_{b} and the second coefficient ωₜ of each pixel of the block of the focused frame, and the quantized data Q_{x,y} of each pixel of the focused frame. The input unit 191 then inputs the second representative values T and the second coefficient ωₜ, the first representative values B and the first coefficient ω_{b}, and the quantized data Q_{x,y} to the linear predictor 192, the linear predictor 193, and the dequantizer 108, respectively. The process then proceeds to STEP S122.

At STEP S122, the linear predictor 193 stores the first representative values B of all blocks of the focused frame and the first coefficient ω_{b} of each pixel of the block of the focused frame supplied from the input unit 191 in the memory 193a included therein.

In addition, at STEP S122, the linear predictor 193 performs processing similar to that performed by the linear predictor 153 shown in FIG. 10 using the first representative values B and the first coefficient ω_{b} stored in the memory 193a while sequentially setting each pixel of the focused frame as the focused pixel to determine the first reference value b_{x,y}, which is the same as the first reference value b_{x,y} output by the linear predictor 153 shown in FIG. 10. The linear predictor 193 supplies the first reference value b_{x,y} to the reference value difference extractor 106 and the adder 109. The process then proceeds to STEP S123.

At STEP S123, the linear predictor 192 stores the second representative values T of all blocks of the focused frame and the second coefficient ωₜ of each pixel of the block of the focused frame supplied from the input unit 191 in the memory 192a included therein.

In addition, at STEP S123, the linear predictor 192 performs processing similar to that performed by the linear predictor 156 shown in FIG. 10 using the second representative values T and the second coefficient ωₜ stored in the memory 192a to determine the second reference value t_{x,y}, which is the same as the second reference value t_{x,y} output by the linear predictor 156 shown in FIG. 10. The linear predictor 192 supplies the second reference value t_{x,y} to the reference value difference extractor 106. The process then proceeds to STEP S124. At STEPs S124 to S128, processing similar to that of STEPs S64 to S68 shown in FIG. 8 is performed.

After the processing of STEP S128, the process proceeds to STEP S129. The linear predictor 193 determines whether the process is completed regarding all decoding-target coded data.

If it is determined that the process is not completed regarding all decoding-target coded data at STEP S129, the process returns to STEP S121. At STEP S121, the input unit 191 repeats the similar processing while setting supplied coded data of a new frame as coded data of a new focused frame.

On the other hand, if it is determined that the process is completed regarding all decoding-target coded data at STEP S129, the decoding process is terminated.

In the decoding process shown in FIG. 13, since the quantization step Δ_{x,y} is calculated on the basis of the reference value difference D_{x,y} that is minimized by the coding apparatus 31 shown in FIG. 10, the quantization step Δ_{x,y} proportional to the reference value difference D_{x,y} can be made smaller. Accordingly, a quantization error resulting from the dequnatization can be reduced, which can improve an S/N ratio of decoded image data and can provide decoded image data including a preferable gradation part or the like.

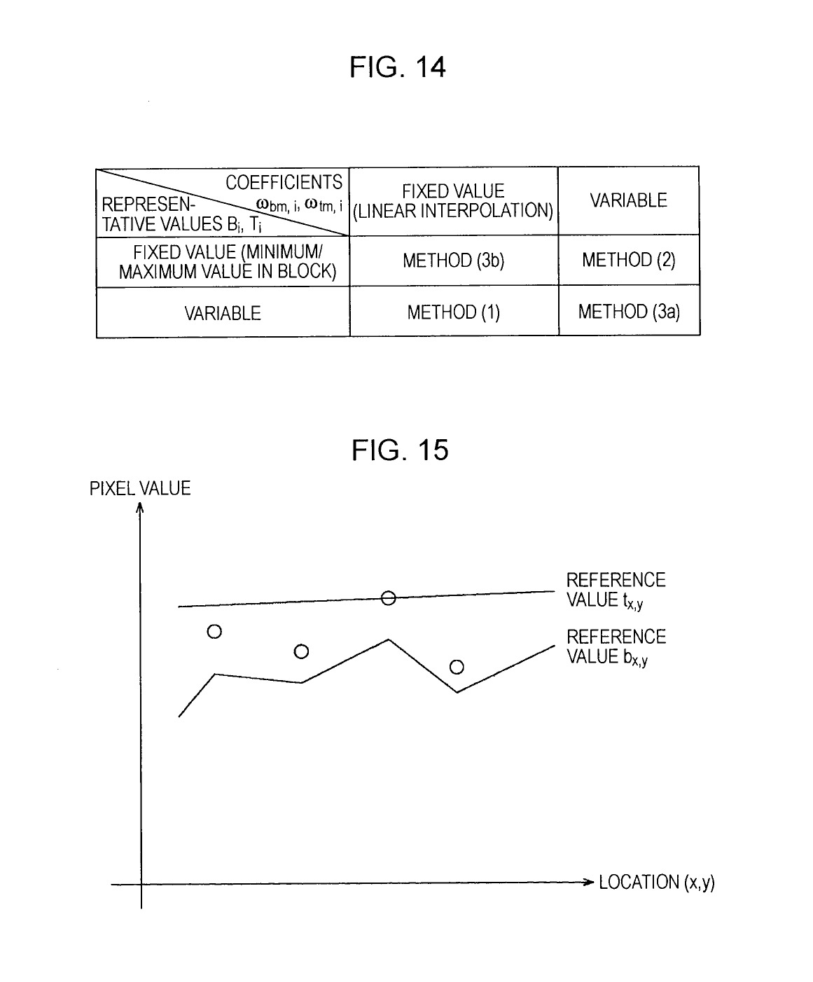

The coding apparatus 31 shown in FIG. 3 calculates the reference value b_{x,y} (t_{x,y}) using a fixed coefficient ω_{b} (ωₜ) and a variable representative value B (T), whereas the coding apparatus 31 shown in FIG. 10 calculates the reference value b_{x,y} using a variable coefficient ω_{b} and a minimum (maximum) pixel value of a block serving as a fixed representative value. However, as shown in FIG. 14, the reference value b_{x,y} can be calculated using methods other than these methods.

FIG. 14 shows four methods for calculating the reference value b_{x,y} (t_{x,y}).

There are following methods for calculating the reference value b_{x,y} (the same applies to the method for calculating the reference value t_{x,y}): a method (1) for calculating the first reference value b_{x,y} using the first coefficient ω_{bm,i} and the first representative value Bᵢ after determining the variable first representative value Bᵢ while recognizing the first coefficient ω_{bm,i} and the first representative value Bᵢ of Equation (1) are a fixed value and a variable, respectively; a method (2) for calculating the first reference value b_{x,y} using the first coefficient ω_{bm,i} and the first representative value Bᵢ after determining the variable first coefficient ω_{bm,i} while recognizing the first coefficient ω_{bm,i} and the first representative value Bᵢ are a variable and a fixed value, respectively; a method (3a) for calculating the first reference value b_{x,y} using the first coefficient ω_{bm,i} and the first representative value Bᵢ after determining the variable first coefficient ω_{bm,i} and the variable first representative value Bᵢ while recognizing both of the first coefficient ω_{bm,i} and the first representative value Bᵢ are variables; and a method (3b) for calculating the first reference value b_{x,y} using the fixed first coefficient ω_{bm,i} and the fixed first representative value Bᵢ while recognizing both of the first coefficient ω_{bm,i} and the first representative value Bᵢ are fixed values.

The coding apparatus 31 shown in FIG. 3 calculates the first reference value b_{x,y} using the method (1), whereas the coding apparatus 31 shown in FIG. 10 calculates the first reference value b_{x,y} using the method (2).

The method (3a) is realized by combining the methods (1) and (2). More specifically, in the method (3a), the variable first coefficient ω_{bm,i} is first determined while recognizing the first coefficient ω_{bm,i} and the first representative value Bᵢ as a variable and a fixed value, respectively, using the method (2). The variable first representative value Bᵢ is then determined while fixing the first coefficient ω_{bm,i} to a value determined using the method (2) using the method (1). Thereafter, the first reference value b_{x,y} is calculated using the first coefficient ω_{bm,i} calculated in the method (2) and the representative value Bᵢ calculated in the method (1).

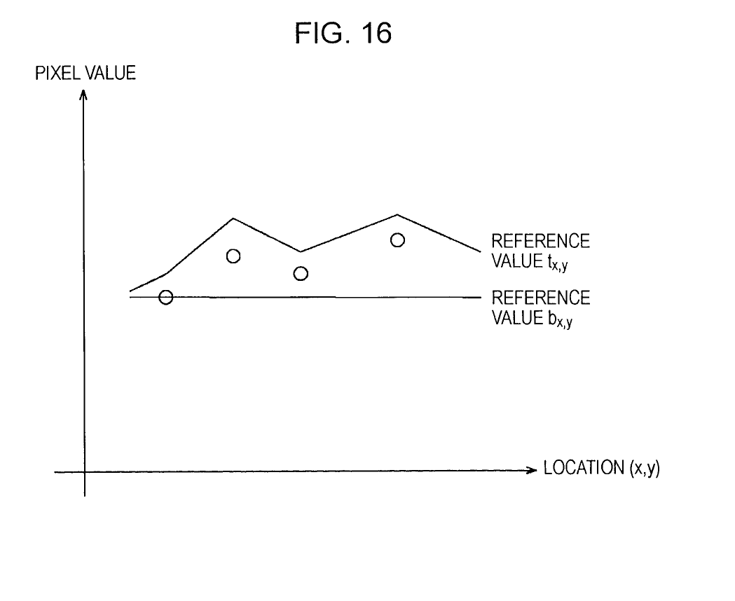

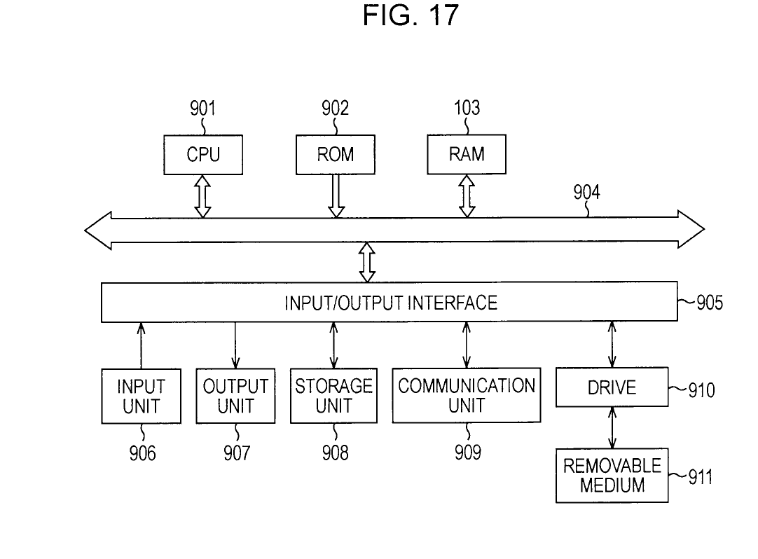

In addition, in the above-described embodiment, optimization of the first reference value b_{x,y} (determination of the first reference value b_{x,y}, not greater than the pixel value p_{x,y}, that minimizes the difference p_{x,y}−b_{x,y} between the pixel value p_{x,y} and the first reference value b_{x,y}) and optimization of the second reference value t_{x,y} (determination of the second reference value t_{x,y}, not smaller than the pixel value p_{x,y}, that minimizes the difference t_{x,y}−p_{x,y} between the second reference value t_{x,y} and the pixel value p_{x,y}) are performed. However, the optimization may be performed regarding one of the first reference value b_{x,y} and the second reference value t_{x,y} and a fixed value may be employed as the other value as shown in FIGS. 15 and 16.

More specifically, FIG. 15 shows a case where the second reference value t_{x,y} is fixed and the first reference value b_{x,y} is optimized.

In addition, FIG. 16 shows a case where the first reference value b_{x,y} is fixed and the second reference value t_{x,y} is optimized.

Referring to FIGS. 15 and 16, the horizontal axis represents a location(x,y) of a pixel of a block, whereas the vertical axis represents a pixel value of the pixel.

In addition, in FIG. 15, the maximum pixel value of the block is employed as the fixed second reference value t_{x,y}. In FIG. 16, the minimum pixel value of the block is employed as the fixed first reference value b_{x,y}.

Furthermore, a case where the first reference value b_{x,y} or the second reference value t_{x,y} is optimized equates to a case where the first reference value b_{x,y} and the reference value difference D_{x,y} or the second reference value t_{x,y} and the reference value difference D_{x,y} are optimized.

Dedicated hardware or software can execute the coding processes (FIGS. 6 and 11) performed by the coding apparatus 31 and the decoding processes (FIGS. 8 and 13) performed by the decoding apparatus 32. When the above-described coding processes and decoding processes are executed by software, programs constituting the software are installed, from a program recording medium, in an embedded computer or, for example, a general-purpose computer capable of executing various functions by installing various programs.

FIG. 17 is a block diagram showing a configuration example of a computer executing the above-described coding and decoding processes using programs.

A central processing unit (CPU) 901 executes various processes according to programs stored in a read only memory (ROM) 902 or a storage unit 908. A random access memory (RAM) 903 stores programs executed by the CPU 901 and data. The CPU 901, the ROM 902, and the RAM 903 are connected to each other through a bus 904.

An input/output interface 905 is also connected to the CPU 901 through the bus 904. An input unit 906 such as a keyboard, a mouse, and a microphone and an output unit 907 such as a display and a speaker are connected to the input/output interface 905. The CPU 901 executes various processes according to instructions input from the input unit 906. The CPU 901 also outputs the processing results to the output unit 907.

The storage unit 908 connected to the input/output interface 905 may include, for example, a hard disk, and stores programs executed by the CPU 901 and various kinds of data. A communication unit 909 communicates with external apparatuses via a network, such as the Internet and a local area network (LAN).

A drive 910 connected to the input/output interface 905 drives a removable medium 911, such as a magnetic disk, an optical disk, a magneto-optical disk, or a semiconductor memory, inserted thereto and acquires programs and data recorded on the removable medium 911. The acquired programs and data are transferred to and stored in the storage unit 908, if necessarily.

Kinds of program recording medium that stores programs to be installed in a computer and executed by the computer include the removable medium 911 that is a package medium, such as a magnetic disk (including a flexible disk), an optical disk (including a CD-ROM (Compact Disc-Read Only Memory) and a DVD (Digital Versatile Disc)), an magneto-optical disk, or a semiconductor memory, the ROM 902 temporarily or permanently storing the programs, or a hard disk constituting the storage unit 908. The programs may be stored on the program recording medium through the communication unit 909 serving as an interface, such as a router and a modem, and via a wired or wireless communication medium such as a LAN, the Internet, or digital satellite broadcasting.

In this specification, the steps described in a program recorded on a program recording medium include processing that is executed sequentially in the described order, and also includes processing that is executed in parallel or individually, not necessarily sequentially.

Additionally, in this specification, a system indicates an entire system constituted by a plurality of apparatuses.

Furthermore, in this embodiment, nine first representative values B₀ to B₈ (FIG. 4) and nine first coefficients ω_{bm,0} to ω_{bm,8} for nine (3×3) blocks having a block including a focused pixel at the center are used in the linear operation for determining the first reference value b_{x,y} represented by Equation (1). However, the numbers of the first representative values and the first coefficients used in determination of the first reference value b_{x,y} is not limited to nine.

More specifically, for example, the first reference value b_{x,y} can be determined using five first representative values and five first coefficients corresponding to five blocks including a block having the focused pixel and neighboring blocks located in the upward, downward, left, and right directions of the block. The same applies to the second reference value t_{x,y}.

Furthermore, in this embodiment, the first reference value b_{x,y} that minimizes the difference p_{x,y}−b_{x,y} between the pixel value p_{x,y} and the first reference value b_{x,y} is determined regarding every pixel of one frame. However, a value that minimizes the difference p_{x,y}−b_{x,y} between the pixel value p_{x,y} and the first reference value b_{x,y} may be determined as the first reference value b_{x,y} for example, regarding all pixels of some blocks constituting one frame or regarding all pixels of a plurality of frames. The same applies to the second reference value t_{x,y}.

Additionally, in this embodiment, the difference p_{x,y}−b_{x,y} between the pixel value p_{x,y} and the first reference value b_{x,y} is determined as the pixel value difference d_{x,y} and the pixel value difference d_{x,y} is quantized. The difference p_{x,y}−t_{x,y} between the pixel value p_{x,y} and the second reference value t_{x,y} can be employed as the pixel value difference d_{x,y}. In this case, the second reference value t_{x,y} is added to the pixel value difference d_{x,y} obtained by the dequnatization instead of the first reference value b_{x,y}.

As described above, the coding apparatus 31 calculates the reference value difference D_{x,y}=t_{x,y}−b_{x,y}, which is a difference between the first reference value b_{x,y} and the second reference value t_{x,y} while setting each pixel of the blocks resulting from division of an image into blocks as a focused pixel. Meanwhile, the first and second reference values are two reference values not smaller than and not greater than the pixel value p_{x,y} of the focused pixel. The coding apparatus 31 calculates the pixel value difference d_{x,y}=p_{x,y}−b_{x,y}, which is a difference between the pixel value p_{x,y} of the focused pixel and the first reference value b_{x,y}. The coding apparatus 31 quantizes the pixel value difference d_{x,y} based on the reference value difference D_{x,y}. The coding apparatus 31 determines the first representative value B serving as an operation parameter used in the linear operation for determining the first reference value b_{x,y} represented by Equation (1) or an operation parameter serving as the first coefficient ω_{b} that minimizes the difference p_{x,y}−b_{x,y} between the pixel value p_{x,y} of the focused pixel and the first reference value b_{x,y} determined in the linear operation represented by Equation (1) using the operation parameter (the second representative value T serving as an operation parameter used in the linear operation for determining the second reference value t_{x,y} represented by Equation (4) or an operation parameter serving as the second coefficient ωₜ that minimizes the difference t_{x,y}−p_{x,y} between the second reference value t_{x,y} determined in the linear operation represented by Equation (4) using the operation parameter and the pixel value p_{x,y} of the focused pixel). Therefore, a quantization error can be reduced and decoded image data having a preferable S/N ratio can be obtained.

The present invention is not limited to the above-described embodiments and various modifications can be made without departing from the spirit of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. A coding apparatus that encodes an image, comprising:
blocking means for dividing the image into a plurality of blocks;
reference value acquiring means for acquiring two reference values that are a value not smaller than a pixel value of a focused pixel and a value not greater than the pixel value of the focused pixel when each pixel included in the block is set as the focused pixel;
reference value difference calculation means for calculating a reference value difference that is a difference between the two reference values;
pixel value difference calculation means for calculating a pixel value difference that is a difference between the pixel value of the focused pixel and the reference value;
quantization means for quantizing the pixel value difference on the basis of the reference value difference;
operation parameter calculation means for determining an operation parameter that is used in a predetermined operation for determining the reference values and that minimizes a difference between the pixel value of the focused pixel and the reference value determined in the predetermined operation using the operation parameter; and
output means for outputting a result of quantization performed by the quantization means and the operation parameter as a coded result of the image.

2. The apparatus according to claim 1, wherein the predetermined operation is a linear operation that uses a fixed coefficient and a representative value representing the block, and
wherein the operation parameter calculation means determines the representative value as the operation parameter.

3. The apparatus according to claim 2, wherein, when the reference value not greater than the pixel value of the focused pixel, among the two reference values, is referred to as a first reference value and the reference value not smaller than the pixel value of the focused pixel is referred to as a second reference value, the operation parameter calculation means determines, for each block, a first representative value used in determining the first reference value and a second representative value used in determining the second reference value, and
wherein the reference value acquiring means determines the first reference value using the fixed coefficient and the first representative value and the second reference value using the fixed coefficient and the second representative value to acquire the first and second reference values.

4. The apparatus according to claim 1, wherein the predetermined operation is a linear operation that uses a predetermined coefficient and a maximum pixel value or a minimum pixel value of the block serving as a representative value representing the block, and
wherein the operation parameter calculation means determines the predetermined coefficient as the operation parameter.

5. The apparatus according to claim 4, wherein, when the reference value not greater than the pixel value of the focused pixel, among the two reference values, is referred to as a first reference value and the reference value not smaller than the pixel value of the focused pixel is referred to as a second reference value and the minimum pixel value of the block is set as a first representative value and the maximum pixel value of the block is set as a second representative value, the operation parameter calculation means determines a first coefficient used in determining the first reference value along with the first representative value and a second coefficient used in determining the second reference value along with the second representative value, and
wherein the reference value acquiring means determines the first reference value using the first coefficient and the first representative value and the second reference value using the second coefficient and the second representative value to acquire the first and second reference values.

6. A coding method for a coding apparatus that encodes an image, the coding method comprising the steps of:
dividing the image into a plurality of blocks;
acquiring two reference values that are a value not smaller than a pixel value of a focused pixel and a value not greater than the pixel value of the focused pixel when each pixel included in the block is set as the focused pixel;
calculating a reference value difference that is a difference between the two reference values;
calculating a pixel value difference that is a difference between the pixel value of the focused pixel and the reference value;
quantizing the pixel value difference on the basis of the reference value difference;
determining an operation parameter that is used in a predetermined operation for determining the reference values and that minimizes a difference between the pixel value of the focused pixel and the reference value determined in the predetermined operation using the operation parameter; and
outputting a result of quantization of the pixel value difference and the operation parameter as a coded result of the image.

7. A program allowing a computer to function as a coding apparatus that encodes an image, the program allowing the computer to function as:
blocking means for dividing the image into a plurality of blocks;
reference value acquiring means for acquiring two reference values that are a value not smaller than a pixel value of a focused pixel and a value not greater than the pixel value of the focused pixel when each pixel included in the block is set as the focused pixel;
reference value difference calculation means for calculating a reference value difference that is a difference between the two reference values;
pixel value difference calculation means for calculating a pixel value difference that is a difference between the pixel value of the focused pixel and the reference value;
quantization means for quantizing the pixel value difference on the basis of the reference value difference;
operation parameter calculation means for determining an operation parameter that is used in a predetermined operation for determining the reference values and that minimizes a difference between the pixel value of the focused pixel and the reference value determined in the predetermined operation using the operation parameter; and
output means for outputting a result of quantization performed by the quantization means and the operation parameter as a coded result of the image.

8. A decoding apparatus that decodes coded data of an image, the coded data including a quantized result of a pixel value difference and an operation parameter obtained by calculating a reference value difference between two reference values that are a value not smaller than a pixel value of a focused pixel and a value not greater than the pixel value of the focused pixel when each pixel of a block resulting from division of an image into blocks is set as the focused pixel, by calculating the pixel value difference between the pixel value of the focused pixel and the reference value, by quantizing the pixel value difference on the basis of the reference value difference, and by determining the operation parameter that is used in a predetermined operation for determining the reference values and that minimizes a difference between the pixel value of the focused pixel and the reference value determined in the predetermined operation using the operation parameter, the decoding apparatus comprising:
reference value acquiring means for performing the predetermined operation using the operation parameter to acquire the two reference values;
reference value difference acquiring means for acquiring the reference value difference that is a difference between the two reference values;
dequantization means for dequantizing the quantized result on the basis of the reference value difference to determine the pixel value difference; and
addition means for adding the pixel value difference and the reference value.

9. The apparatus according to claim 8, wherein the operation parameter is a representative value representing the block, and
wherein the reference value acquiring means performs a linear operation that uses a fixed coefficient and the representative value as the predetermined operation to acquire the reference values.

10. The apparatus according to claim 9, wherein, when the reference value not greater than the pixel value of the focused pixel, among the two reference values, is referred to as a first reference value and the reference value not smaller than the pixel value of the focused pixel is referred to as a second reference value, the operation parameters are a first representative value used in determining the first reference value and a second representative value used in determining the second reference value, the first and second representative values being determined for each block, and
wherein the reference value acquiring means determines the first reference value using the fixed coefficient and the first representative value and the second reference value using the fixed coefficient and the second representative value to acquire the first and second reference values.

11. The apparatus according to claim 8, wherein the operation parameter is a predetermined coefficient, and
wherein the reference value acquiring means performs a linear operation, as the predetermined operation, using the predetermined coefficient and a minimum pixel value or a maximum pixel value of the block serving as the representative value representing the block to acquire the reference values.

12. The apparatus according to claim 11, wherein, when the reference value not greater than the pixel value of the focused pixel, among the two reference values, is referred to as a first reference value and the reference value not smaller than the pixel value of the focused pixel is referred to as a second reference value and the minimum pixel value of the block is set as a first representative value and the maximum pixel value of the block is set as a second representative value, the operation parameters are a first coefficient used in determining the first reference value along with the first representative value and a second coefficient used in determining the second reference value along with the second representative value, and
wherein the reference value acquiring means determines the first reference value using the first coefficient and the first representative value and the second reference value using the second coefficient and the second representative value to acquire the first and second reference values.

13. A decoding method for a decoding apparatus that decodes coded data of an image, the coded data including a quantized result of a pixel value difference and an operation parameter obtained by calculating a reference value difference between two reference values that are a value not smaller than a pixel value of a focused pixel and a value not greater than the pixel value of the focused pixel when each pixel of a block resulting from division of an image into blocks is set as the focused pixel, by calculating the pixel value difference between the pixel value of the focused pixel and the reference value, by quantizing the pixel value difference on the basis of the reference value difference, and by determining the operation parameter that is used in a predetermined operation for determining the reference values and that minimizes a difference between the pixel value of the focused pixel and the reference value determined in the predetermined operation using the operation parameter, the method comprising the steps of:
performing the predetermined operation using the operation parameter to acquire the reference values;
acquiring the reference value difference that is a difference between the two reference values;
dequantizing the quantized result on the basis of the reference value difference to determine the pixel value difference; and
adding the pixel value difference and the reference value.

14. A program allowing a computer to function as a decoding apparatus that decodes coded data of an image, the coded data including a quantized result of a pixel value difference and an operation parameter obtained by calculating a reference value difference between two reference values that are a value not smaller than a pixel value of a focused pixel and a value not greater than the pixel value of the focused pixel when each pixel of a block resulting from division of an image into blocks is set as the focused pixel, by calculating the pixel value difference between the pixel value of the focused pixel and the reference value, by quantizing the pixel value difference on the basis of the reference value difference, and by determining the operation parameter that is used in a predetermined operation for determining the reference values and that minimizes a difference between the pixel value of the focused pixel and the reference value determined in the predetermined operation using the operation parameter, the program allowing the computer to function as:
reference value acquiring means for performing the predetermined operation using the operation parameter to acquire the two reference values;
reference value difference acquiring means for acquiring the reference value difference that is a difference between the two reference values;
dequantization means for dequantizing the quantized result on the basis of the reference value difference to determine the pixel value difference; and
addition means for adding the pixel value difference and the reference value.

15. A coding apparatus that encodes an image, comprising:
a blocking unit configured to divide the image into a plurality of blocks;
a reference value acquiring unit configured to acquire two reference values that are a value not smaller than a pixel value of a focused pixel and a value not greater than the pixel value of the focused pixel when each pixel included in the block is set as the focused pixel;
a reference value difference calculation unit configured to calculate a reference value difference that is a difference between the two reference values;
a pixel value difference calculation unit configured to calculate a pixel value difference that is a difference between the pixel value of the focused pixel and the reference value;
a quantization unit configured to quantize the pixel value difference on the basis of the reference value difference;
an operation parameter calculation unit configured to determine an operation parameter that is used in a predetermined operation for determining the reference values and that minimizes a difference between the pixel value of the focused pixel and the reference value determined in the predetermined operation using the operation parameter; and
an output unit configured to output a result of quantization performed by the quantization unit and the operation parameter as a coded result of the image.

16. A decoding apparatus that decodes coded data of an image, the coded data including a quantized result of a pixel value difference and an operation parameter obtained by calculating a reference value difference between two reference values that are a value not smaller than a pixel value of a focused pixel and a value not greater than the pixel value of the focused pixel when each pixel of a block resulting from division of an image into blocks is set as the focused pixel, by calculating the pixel value difference between the pixel value of the focused pixel and the reference value, by quantizing the pixel value difference on the basis of the reference value difference, and by determining the operation parameter that is used in a predetermined operation for determining the reference values and that minimizes a difference between the pixel value of the focused pixel and the reference value determined in the predetermined operation using the operation parameter, the decoding apparatus comprising:
a reference value acquiring unit configured to perform the predetermined operation using the operation parameter to acquire the two reference values;
a reference value difference acquiring unit configured to acquire the reference value difference that is a difference between the two reference values;
a dequantization unit configured to dequantize the quantized result on the basis of the reference value difference to determine the pixel value difference; and
an addition unit configured to add the pixel value difference and the reference value.
